(19) United States
(12) Patent Application Publication
(10) Pub. No.: US 2025/0330846 A1
(43) Pub. Date: Oct. 23, 2025

(54) QUALITY OF EXPERIENCE MEASUREMENT AND REPORTING IN IDLE AND INACTIVE STATES

(71) Applicant: QUALCOMM INCORPORATED, San Diego, CA (US)

(72) Inventors: Rajeev Kumar, San Diego, CA (US); Jianhua Liu, Beijing (CN); Xipeng Zhu, San Diego, CA (US); Shankar Krishnan, Poway, CA (US)

(21) Appl. No.: 18/861,855

(22) PCT Filed: Jul. 4, 2022
(86) PCT No.: PCT/CN2022/103587

§ 371 Date: Oct. 30, 2024

(51) Int. Cl. H04W 24/08; H04W 76/27

(52) U.S. Cl. CPC H04W 24/08; H04W 76/27

(57) ABSTRACT

Methods, systems, and devices for wireless communications are described. A user equipment (UE) may perform, while operating in a connected state, a first set of quality of experience (QoE) measurements in accordance with a first QoE measurement and reporting configuration associated with the connected state. The UE may then transition from the connected state to one of an idle state or an inactive state. The UE may then perform, while operating in the idle state or the inactive state, a second set of QoE measurements in accordance with a second QoE measurement and reporting configuration associated with the idle state, the inactive state, or both, where the second QoE measurement and reporting configuration is different from the first QoE measurement and reporting configuration. The UE may then transmit, to a network entity, a QoE report including at least the second set of QoE measurements.

### CROSS REFERENCE

The present application is a 371 national stage filing of International PCT Application No. PCT/CN2022/103587 by Kumar et al. entitled “QUALITY OF EXPERIENCE MEASUREMENT AND REPORTING IN IDLE AND INACTIVE STATES,” filed Jul. 4, 2022, which is assigned to the assignee hereof, and which is expressly incorporated by reference in its entirety herein.

### FIELD OF TECHNOLOGY

The following relates to wireless communications, including quality of experience (QoE) measurement and reporting in idle and inactive states.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems enable UEs to report quality of experience (QoE) measurements to the network. As compared to quality of service (QoS) metrics, known as Minimization of Drive Test (MDT) measurements in 3GPP systems, which are associated with a relative quality of wireless communications within lower layers such as Packet Data Convergence Protocol (PDCP), Radio Link Control (RLC), Medium Access Control (MAC) layers, and physical layer, QoE measurements are associated with a quality of experience of application services (such as Multimedia Telephony Service for IMS (MTSI), streaming service, virtual reality (VR) service, Multicast Broadcast Service (MBS), and others) at the application layer provisioned over wireless communications to the UE. A few examples of QoE measurements may include, but are not limited to, block error rate (BLER) at the UE, quality of streamed videos at the UE, buffering delay at the UE, and play back delay.

### SUMMARY

The invention is defined by the claims. Embodiments, examples, and aspects that deviate from (e.g., do not fall within) the scope of the claims are merely examples used for explanation of the invention.

The described techniques relate to improved methods, systems, devices, and apparatuses that support techniques for quality of experience (QoE) measurement and reporting in idle and inactive states. Generally, aspects of the present disclosure support techniques which enable a user equipment (UE) to perform quality of experience (QoE) measurements, report QoE measurements, or both, while operating in idle or inactive states. In particular, techniques described herein may enable UEs to be configured with QoE measurement and reporting configurations which enable the UEs to perform QoE measurements during idle/inactive states. Moreover, QoE measurement and reporting configurations described herein may enable UEs to transition to a connected state to transmit a QoE report and/or transmit a QoE report while operating in the idle/inactive state. In some aspects, UEs may be configured with a single QoE measurement and reporting configuration that is usable for connected, idle, and inactive states. In such cases, parameters of the QoE measurement and reporting configuration (e.g., periodicity of QoE measurements and/or QoE measurements metrics) may be updated as the UE transitions between states, such as via radio resource control (RRC) release messages which release the UE from the connected state to the idle/inactive state and via RRCReconfiguration message when UE transition back to connected state from idle/inactive state. In additional or alternative cases, the UE may be configured with separate QoE measurement and reporting configurations for the connected and idle/inactive states. In some cases, a UE may perform QoE measurements while in the idle/inactive state, and may store QoE measurements in memory until the UE transitions to the connected state and can send a QoE report indicating stored measurements. QoE measurement and reporting configurations may include trigger conditions which cause the UE to transition from the idle/inactive state to the connected state to transmit a QoE report.

A method for wireless communication at a UE is described. The method may include performing, while operating in a connected state, a first set of QoE measurements in accordance with a first QoE measurement and reporting configuration associated with the connected state, transitioning from the connected state to one of an idle state or an inactive state, performing, while operating in the idle state or the inactive state, a second set of QoE measurements in accordance with a second QoE measurement and reporting configuration associated with the idle state, the inactive state, or both, the second QoE measurement and reporting configuration different from the first QoE measurement and reporting configuration, and transmitting, to a network entity, a QoE report including at least the second set of QoE measurements.

An apparatus for wireless communication at a UE is described. The apparatus may include a processor, memory coupled with the processor, and instructions stored in the memory. The instructions may be executable by the processor to cause the apparatus to perform, while operating in a connected state, a first set of QoE measurements in accordance with a first QoE measurement and reporting configuration associated with the connected state, transition from the connected state to one of an idle state or an inactive state, perform, while operating in the idle state or the inactive state, a second set of QoE measurements in accordance with a second QoE measurement and reporting configuration associated with the idle state, the inactive state, or both, the second QoE measurement and reporting configuration different from the first QoE measurement and reporting configuration, and transmit, to a network entity, a QoE report including at least the second set of QoE measurements.

Another apparatus for wireless communication at a UE is described. The apparatus may include means for performing, while operating in a connected state, a first set of QoE measurements in accordance with a first QoE measurement and reporting configuration associated with the connected state, means for transitioning from the connected state to one of an idle state or an inactive state, means for performing, while operating in the idle state or the inactive state, a second set of QoE measurements in accordance with a second QoE measurement and reporting configuration associated with the idle state, the inactive state, or both, the second QoE measurement and reporting configuration different from the first QoE measurement and reporting configuration, and means for transmitting, to a network entity, a QoE report including at least the second set of QoE measurements.

A non-transitory computer-readable medium storing code for wireless communication at a UE is described. The code may include instructions executable by a processor to perform, while operating in a connected state, a first set of QoE measurements in accordance with a first QoE measurement and reporting configuration associated with the connected state, transition from the connected state to one of an idle state or an inactive state, perform, while operating in the idle state or the inactive state, a second set of QoE measurements in accordance with a second QoE measurement and reporting configuration associated with the idle state, the inactive state, or both, the second QoE measurement and reporting configuration different from the first QoE measurement and reporting configuration, and transmit, to a network entity, a QoE report including at least the second set of QoE measurements.

Some examples of the method, apparatuses, and non-transitory computer-readable medium described herein may further include operations, features, means, or instructions for receiving, from the network entity, a control message instructing the UE to transition from the connected state to the idle state or the inactive state, the control message modifying one or more parameters associated with the first QoE measurement and reporting configuration, where transitioning to the idle state or the inactive state may be based on the control message, and where the second QoE measurement and reporting configuration includes a modified version of the first QoE measurement and reporting configuration based on the control message.

In some examples of the method, apparatuses, and non-transitory computer-readable medium described herein, the control message includes an RRC release message.

Some examples of the method, apparatuses, and non-transitory computer-readable medium described herein may further include operations, features, means, or instructions for receiving, from the network entity, a control message indicating the first QoE measurement and reporting configuration and the second QoE measurement and reporting configuration, where performing the first set of QoE, measurements, performing the second set of QoE measurements, or both, may be based on the control message.

Some examples of the method, apparatuses, and non-transitory computer-readable medium described herein may further include operations, features, means, or instructions for receiving, from the network entity, a control message instructing the UE to transition from the connected state to the idle state or the inactive state, the control message indicating the second QoE measurement and reporting configuration, where transitioning to the idle state or the inactive state and performing the second set of QoE measurements may be based on the control message.

Some examples of the method, apparatuses, and non-transitory computer-readable medium described herein may further include operations, features, means, or instructions for storing the second set of QoE measurements in memory in accordance with the second QoE measurement and reporting configuration while operating in the idle state or the inactive state and transitioning from the idle state or the inactive state to the connected state, where transmitting the QoE report occurs after transitioning to the connected state and may be based on storing the second set of QoE measurements in memory while operating in the idle state or the inactive state.

Some examples of the method, apparatuses, and non-transitory computer-readable medium described herein may further include operations, features, means, or instructions for identifying a satisfaction of a trigger condition for QoE reporting while operating in the idle state or the inactive state and transitioning from the idle state or the inactive state to the connected state based on the satisfaction of the trigger condition, where transmitting the QoE report occurs after transitioning to the connected state.

Some examples of the method, apparatuses, and non-transitory computer-readable medium described herein may further include operations, features, means, or instructions for receiving, from the network entity, a control message indicating a set of multiple trigger conditions for QoE reporting, the set of multiple trigger conditions including the trigger condition, where identifying the satisfaction of the trigger condition may be based on the control message.

Some examples of the method, apparatuses, and non-transitory computer-readable medium described herein may further include operations, features, means, or instructions for determining that at least one QoE measurement of the second set of QoE measurements may be less than or equal to a QoE threshold, where identifying the satisfaction of the trigger condition may be based on the at least one QoE measurement being less than or equal to the QoE threshold.

In some examples of the method, apparatuses, and non-transitory computer-readable medium described herein, and the method, apparatuses, and non-transitory computer-readable medium may include further operations, features, means, or instructions for establishing a wireless connection with a second cell different than the first cell while operating in the idle state or the inactive state, where the QoE report may be transmitted to at least the second cell based on establishing the wireless connection with the second cell, and where the QoE report includes a cell identifier associated with the second cell.

Some examples of the method, apparatuses, and non-transitory computer-readable medium described herein may further include operations, features, means, or instructions for transmitting, to the network entity while operating in the idle state or the inactive state, a request to establish or resume a wireless connection with the network entity and transitioning from the idle state or the inactive state to the connected state based on transmitting the request, where transmitting the QoE report occurs after transitioning to the connected state.

Some examples of the method, apparatuses, and non-transitory computer-readable medium described herein may further include operations, features, means, or instructions for transmitting, to the network entity while operating in the idle state or the inactive state, a request to establish or resume a wireless connection with the network entity and receiving, from the network entity based on the request, an indication of a signaling radio bearer for QoE reporting, where the QoE measurement and reporting configuration may be transmitted via the indicated signaling radio bearer.

Some examples of the method, apparatuses, and non-transitory computer-readable medium described herein may further include operations, features, means, or instructions for receiving, from the network entity, an indication of a signaling radio bearer associated with wireless communications between the UE and the network entity and transmitting the QoE report while operating in the inactive state via the signaling radio bearer based on maintaining the signaling radio bearer as active while operating in the inactive state.

In some examples of the method, apparatuses, and non-transitory computer-readable medium described herein, the second QoE measurement and reporting configuration may be associated with at least radio access network-aware QoE information capable of being decoded by the network entity and the second set of QoE measurements include at least one radio access network-visible QoE measurement capable of being decoded by the network entity.

In some examples of the method, apparatuses, and non-transitory computer-readable medium described herein, the first QoE measurement and reporting configuration may be associated with a first set of parameters, the second QoE measurement and reporting configuration may be associated with a second set of parameters different from the first set of parameters, and the first set of parameters, the second set of parameters, or both, include a measurement periodicity, a reporting periodicity, a measurement quantity, a measurement quality, or any combination thereof.

In some examples of the method, apparatuses, and non-transitory computer-readable medium described herein, the first QoE measurement and reporting configuration may be associated with a first power consumption at the UE and the second QoE measurement and reporting configuration may be associated with a second power consumption at the UE that may be less than the first power consumption.

A method for wireless communication at a network entity is described. The method may include outputting, to a UE, a first control message indicating a first QoE measurement and reporting configuration for the UE to use to perform QoE measurements while in a connected state, outputting, to the UE via the first control message or a second control message, a second QoE measurement and reporting configuration for the UE to use to perform QoE measurements while in an idle state, an inactive state, or both, and obtaining, from the UE, a QoE report including a set of QoE measurements performed while the UE was operating in the idle state or the inactive state and in accordance with the second QoE measurement and reporting configuration.

An apparatus for wireless communication at a network entity is described. The apparatus may include a processor, memory coupled with the processor, and instructions stored in the memory. The instructions may be executable by the processor to cause the apparatus to output, to a UE, a first control message indicating a first QoE measurement and reporting configuration for the UE to use to perform QoE measurements while in a connected state, output, to the UE via the first control message or a second control message, a second QoE measurement and reporting configuration for the UE to use to perform QoE measurements while in an idle state, an inactive state, or both, and obtain, from the UE, a QoE report including a set of QoE measurements performed while the UE was operating in the idle state or the inactive state and in accordance with the second QoE measurement and reporting configuration.

Another apparatus for wireless communication at a network entity is described. The apparatus may include means for outputting, to a UE, a first control message indicating a first QoE measurement and reporting configuration for the UE to use to perform QoE measurements while in a connected state, means for outputting, to the UE via the first control message or a second control message, a second QoE measurement and reporting configuration for the UE to use to perform QoE measurements while in an idle state, an inactive state, or both, and means for obtaining, from the UE, a QoE report including a set of QoE measurements performed while the UE was operating in the idle state or the inactive state and in accordance with the second QoE measurement and reporting configuration.

A non-transitory computer-readable medium storing code for wireless communication at a network entity is described. The code may include instructions executable by a processor to output, to a UE, a first control message indicating a first QoE measurement and reporting configuration for the UE to use to perform QoE measurements while in a connected state, output, to the UE via the first control message or a second control message, a second QoE measurement and reporting configuration for the UE to use to perform QoE measurements while in an idle state, an inactive state, or both, and obtain, from the UE, a QoE report including a set of QoE measurements performed while the UE was operating in the idle state or the inactive state and in accordance with the second QoE measurement and reporting configuration.

In some examples of the method, apparatuses, and non-transitory computer-readable medium described herein, the second control message instructs the UE to transition from the connected state to the idle state or the inactive state and modifies one or more parameters associated with the first QoE measurement and reporting configuration and the second QoE measurement and reporting configuration includes a modified version of the first QoE measurement and reporting configuration based on the second control message.

In some examples of the method, apparatuses, and non-transitory computer-readable medium described herein, the second control message includes an RRC release message.

In some examples of the method, apparatuses, and non-transitory computer-readable medium described herein, the second control message instructs the UE to transition from the connected state to the idle state or the inactive state and indicates the second QoE measurement and reporting configuration and obtaining the QoE report may be based on the second control message.

Some examples of the method, apparatuses, and non-transitory computer-readable medium described herein may further include operations, features, means, or instructions for indicating, to the UE via the first control message, the second control message, an additional control message, or any combination thereof, a set of multiple trigger conditions for QoE reporting, where receiving the QoE report may be based on a satisfaction of a trigger condition from the set of multiple trigger conditions.

Some examples of the method, apparatuses, and non-transitory computer-readable medium described herein may further include operations, features, means, or instructions for obtaining, from the UE, a request to establish or resume a wireless connection with the network entity, where obtaining the QoE report occurs after the wireless connection may be established or resumed.

Some examples of the method, apparatuses, and non-transitory computer-readable medium described herein may further include operations, features, means, or instructions for obtaining, from the UE, a request to establish or resume a wireless connection with the network entity and outputting, to the UE based on the request, an indication of a signaling radio bearer for QoE reporting, where the QoE measurement and reporting configuration may be obtained via the indicated signaling radio bearer.

Some examples of the method, apparatuses, and non-transitory computer-readable medium described herein may further include operations, features, means, or instructions for outputting, to the UE, an indication of a signaling radio bearer associated with wireless communications between the UE and the network entity and obtaining the QoE report from the UE via the signaling radio bearer based on the signaling radio bearer being maintained as active while the UE may be in the inactive state.

In some examples of the method, apparatuses, and non-transitory computer-readable medium described herein, the second QoE measurement and reporting configuration may be associated with at least radio access network-aware QoE information capable of being decoded by the network entity and the set of QoE measurements include at least one radio access network-visible QoE measurement capable of being decoded by the network entity.

In some examples of the method, apparatuses, and non-transitory computer-readable medium described herein, the first QoE measurement and reporting configuration may be associated with a first set of parameters, the second QoE measurement and reporting configuration may be associated with a second set of parameters different from the first set of parameters, and the first set of parameters, the second set of parameters, or both, include a measurement periodicity, a reporting periodicity, a measurement quantity, a measurement quality, or any combination thereof.

In some examples of the method, apparatuses, and non-transitory computer-readable medium described herein, the first QoE measurement and reporting configuration may be associated with a first power consumption at the UE and the second QoE measurement and reporting configuration may be associated with a second power consumption at the UE that may be less than the first power consumption.

### BRIEF DESCRIPTION OF THE DRAWINGS

FIG. 1 illustrates an example of a wireless communications system that supports techniques for quality of experience (QoE) measurement and reporting in idle and inactive states in accordance with one or more aspects of the present disclosure.

FIG. 2 illustrates an example of a network architecture that supports techniques for QoE measurement and reporting in idle and inactive states in accordance with one or more aspects of the present disclosure.

FIG. 3 illustrates an example of a wireless communications system that supports techniques for QoE measurement and reporting in idle and inactive states in accordance with one or more aspects of the present disclosure.

FIG. 4 illustrates an example of a process flow that supports techniques for QoE measurement and reporting in idle and inactive states in accordance with one or more aspects of the present disclosure.

FIG. 5 illustrates an example of a process flow that supports techniques for QoE measurement and reporting in idle and inactive states in accordance with one or more aspects of the present disclosure.

FIG. 6 illustrates an example of a process flow that supports techniques for QoE measurement and reporting in idle and inactive states in accordance with one or more aspects of the present disclosure.

FIGS. 7 and 8 show block diagrams of devices that support techniques for QoE measurement and reporting in idle and inactive states in accordance with one or more aspects of the present disclosure.

FIG. 9 shows a block diagram of a communications manager that supports techniques for QoE measurement and reporting in idle and inactive states in accordance with one or more aspects of the present disclosure.

FIG. 10 shows a diagram of a system including a device that supports techniques for QoE measurement and reporting in idle and inactive states in accordance with one or more aspects of the present disclosure.

FIGS. 11 and 12 show block diagrams of devices that support techniques for QoE measurement and reporting in idle and inactive states in accordance with one or more aspects of the present disclosure.

FIG. 13 shows a block diagram of a communications manager that supports techniques for QoE measurement and reporting in idle and inactive states in accordance with one or more aspects of the present disclosure.

FIG. 14 shows a diagram of a system including a device that supports techniques for QoE measurement and reporting in idle and inactive states in accordance with one or more aspects of the present disclosure.

FIGS. 15 through 18 show flowcharts illustrating methods that support techniques for QoE measurement and reporting in idle and inactive states in accordance with one or more aspects of the present disclosure.

### DETAILED DESCRIPTION

A wireless communications system may enable user equipments (UEs) to report quality of experience (QoE) measurements to the network. QoE measurements may be associated with a quality of experience of application services (such as Multimedia Telephony Service for IMS (MTSI), streaming services, virtual reality (VR) services, Multicast Broadcast Service (MBS), and others) at the application layer provisioned over wireless communications to the UE (e.g., from the perspective of a user of the UE), such as a block error rate (BLER) at the UE, a quality of streamed videos at the UE, or a buffering delay at the UE, among other possible examples—e.g., as compared to quality of service (QOS) metrics or parameters that may instead be associated with a relative quality of wireless communications at the lower layers (e.g. Packet Data Convergence Protocol (PDCP), Radio Link Control (RLC), Medium Access Control (MAC) layers, and Physical layers). A QoE report may include QoE measurements which are decoded and identified by the base station (e.g., “RAN-visible” QoE parameters), as well as QoE measurements which are not decoded by the base station but rather passed on to the Measurement Collection Entity (MCE) for processing (e.g., “RAN-invisible” QoE parameters).

Some communications systems may only enable UEs to perform and report QoE measurements while operating in a radio resource control (RRC) connected state (e.g., RRC_CONNECTED). UEs may also, however, receive communications while operating in other states such as RRC idle and inactive states (e.g., RRC_IDLE, RRC_INACTIVE). For example, a UE may receive emergency broadcast messages while in an idle/inactive state. For wireless communications systems that only enable QoE reporting during a connected state, the UE may be unable to measure and/or report the degraded QoE experienced during the idle/inactive states, which may reduce an ability of the UE to receive and decode such emergency broadcast messages.

Along with supporting the performance, reporting, or both of QoE measurements while a UE is in an idle or inactive state, techniques as described herein may beneficially support the use by a UE of different QoE measurement and reporting configurations when in different states (e.g., when in an idle or inactive state versus when in a connected state). The use of different QoE measurement and reporting configurations when in different states may be beneficial, for example, because utilizing the same QoE measurement and reporting configuration across all states may result in increased power consumption when in the idle/inactive states (e.g., due to using the same QoE measurement and reporting configuration also used in the connected state), thereby reducing the power saving benefits that may otherwise be associated with the idle and inactive states, and resulting in increased power consumption at the UE.

Further, the performance, reporting, or both of QoE measurements while a UE is in an idle or inactive state as described herein may provide additional or alternative benefits as compared to other types of measurements. For example, in some cases, a UE may perform minimization of drive test (MDT) measurements, known as logged measurement or logged MDT, while in an idle or inactive state, and may transmit the MDT measurements via a QoE report after transitioning to the connected state. However, MDT measurements are associated with a different layer as QoE measurements and serve a different purpose than QoE measurements. In particular, QoE measurements may include upper layer measurements (e.g., application layer measurements), whereas MDT measurements may include lower layer measurements (e.g., PDCP, RLC, MAC, and physical layer measurements). Additionally, MDT measurements are primarily used for coverage optimization purposes (e.g., to improve coverage across a network), whereas QoE measurements are related to the relative quality the application services performed via (e.g., provisioned over) wireless communications perceived or measured at the UE, and therefore may, for example, be used for encoding/decoding to verify or optimize encoder and decoder operations at the network entity (e.g., application server). As such, the performance, reporting, or both of QoE measurements while a UE is in an idle or inactive state as described herein may serve distinct purposes and provide distinct benefits as compared to other types of measurements and may enable the network to improve a quality of application services provisioned over wireless communications experienced at the UE while operating in the idle/inactive states in a way that may not be supported by such other types of measurements.

Accordingly, aspects of the present disclosure may support techniques which enable a UEs to perform QoE measurements, report QoE measurements, or both, associated with operating in idle or inactive states. In particular, techniques described herein may enable UEs to be configured with QoE measurement and reporting configurations which enable the UEs to perform QoE measurements during idle/inactive states, while simultaneously enabling the UEs to reduce power consumption while operating in the idle and inactive states. Moreover, QoE measurement and reporting configurations described herein may enable UEs to transition to a connected state to transmit a QoE report and/or transmit a QoE report while operating in the idle/inactive state.

In some aspects, UEs may be configured with a single QoE measurement and reporting configuration that is usable for connected, idle, and inactive states, where the single QoE measurement and reporting configuration is modified or updated as the UE transitions between states in order to bring into effect a different QoE measurement and reporting configuration for the different states based on such transition-related modifications or updates. For example, in such cases, parameters of the QoE measurement and reporting configuration (e.g., periodicity of QoE measurements and/or and QoE measurements metrics) may be updated as the UE transitions between states, such as via RRC release messages which release the UE from the connected state to the idle/inactive state. In additional or alternative cases, the UE may be configured (e.g., via a single configuration message) with separate QoE measurement and reporting configurations for the connected and idle/inactive states. In some cases, a UE may perform QoE measurements while in the idle/inactive state, and may store QoE measurements in memory until the UE transitions to the connected state and can send a QoE report indicating stored measurements. QoE measurement and reporting configurations may include trigger conditions which cause the UE to transition from the idle/inactive state to the connected state to transmit a QoE report. For example, if a QoE measurement falls below a threshold while in the idle/inactive state, the UE may transition from the idle/inactive state to the connected state to report the declining QoE measurements experienced during the idle/inactive states.

Aspects of the disclosure are initially described in the context of wireless communications systems. Additional aspects of the disclosure are described in the context of example process flows. Aspects of the disclosure are further illustrated by and described with reference to apparatus diagrams, system diagrams, and flowcharts that relate to techniques for QoE measurement and reporting in idle and inactive states.

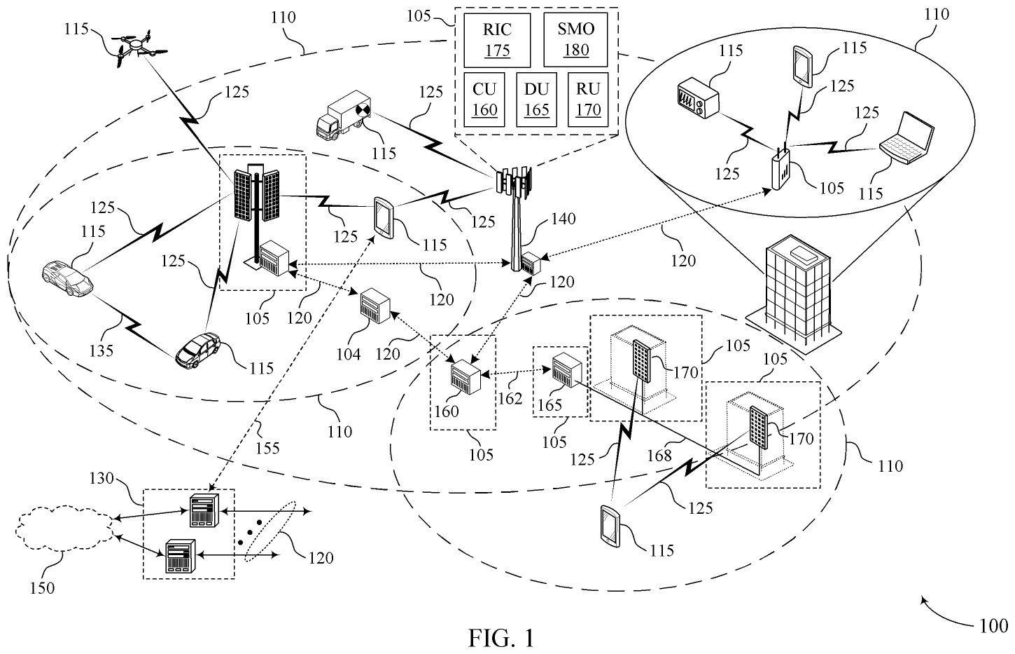

FIG. 1 illustrates an example of a wireless communications system 100 that supports techniques for QoE measurement and reporting in idle and inactive states in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for QoE measurement and reporting in idle and inactive states as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), a control message that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving.” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some aspects, the UEs 115 and the network entities 105 (e.g., base stations) of the wireless communications system 100 may support signaling and techniques which enable UEs 115 to perform QoE measurements, report QoE measurements, or both, associated with operating in idle or inactive states. In particular, techniques described herein may enable UEs 115 of the wireless communications system 100 to be configured with QoE measurement and reporting configurations which enable the UEs 115 to perform QoE measurements during idle/inactive states, while simultaneously reducing power consumption while in the idle/inactive states. Moreover, QoE measurement and reporting configurations described herein may enable UEs 115 to transition to a connected state to transmit a QoE report and/or transmit a QoE report while operating in the idle/inactive state.

In some aspects, UEs 115 of the wireless communications system 100 may be configured with a single QoE measurement and reporting configuration that is usable for connected, idle, and inactive states, where parameters of the single QoE measurement and reporting configuration (e.g., periodicity of QoE measurements and/or and QoE measurements metrics) are updated or modified as the UE 115 transitions between states. For example, a network entity 105 may release a UE 115 from the connected state to an idle or inactive state via an RRC release message, where the RRC release message selectively adjusts or updates one or more parameters of the QoE measurement and reporting configuration (e.g., periodicity of QoE measurements and/or and QoE measurements metrics). In additional or alternative cases, a UE 115 may be configured with separate QoE measurement and reporting configurations for the connected and idle/inactive states. For example, a UE 115 may be configured with a first QoE measurement and reporting configuration usable during times when the UE 115 is in the connected state, and a second QoE measurement and reporting configuration usable when the UE 115 is in the idle or inactive state. In this example, the second QoE measurement and reporting configuration may be associated with a less frequent QoE measurement periodicity as compared to the first QoE configuration to reduce power consumption of the UE 115 during the idle/inactive state.

In some implementations, a UE 115 may perform QoE measurements while in the idle/inactive state, and may store QoE measurements in memory until the UE 115 transitions to the connected state and is able to send a QoE report indicating stored measurements. In some aspects, QoE measurement and reporting configurations described herein may include trigger conditions which cause the UE 115 to transition from the idle/inactive state to the connected state to transmit a QoE report. For example, if a QoE measurement falls below a threshold while in the idle/inactive state, the UE 115 may identify a satisfaction of a trigger condition which causes the UE 115 to transition from the idle/inactive state to the connected state to report the declining QoE measurements experienced during the idle/inactive states.

Techniques described herein may enable UEs 115 to perform QoE measurements while operating in an idle state, an inactive state, or both. As such, techniques described herein may enable UEs 115 to inform the network as to a relative quality of wireless communications received at the UE 115 during the idle and inactive states, including a relative quality of emergency broadcast messages. As such, aspects of the present disclosure may enable the network to adjust parameters of wireless communications to improve a relative quality of such wireless communications received by the UE 115 during the idle and inactive states. In this regard, aspects of the present disclosure may facilitate improved coordination between the UE 115 and the network, and improve an efficiency and reliability of application services provisioned over wireless communications received by the UE 115 during inactive and idle states.

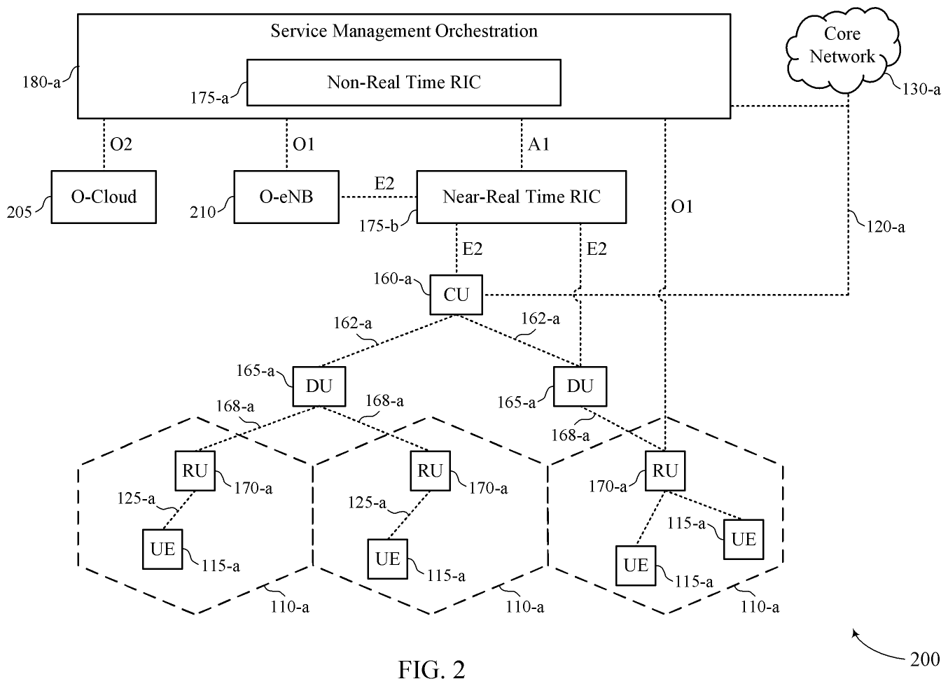

FIG. 2 illustrates an example of a network architecture 200 that (e.g., a disaggregated base station architecture, a disaggregated RAN architecture) that supports techniques for QoE measurement and reporting in idle and inactive states in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or a transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g. via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

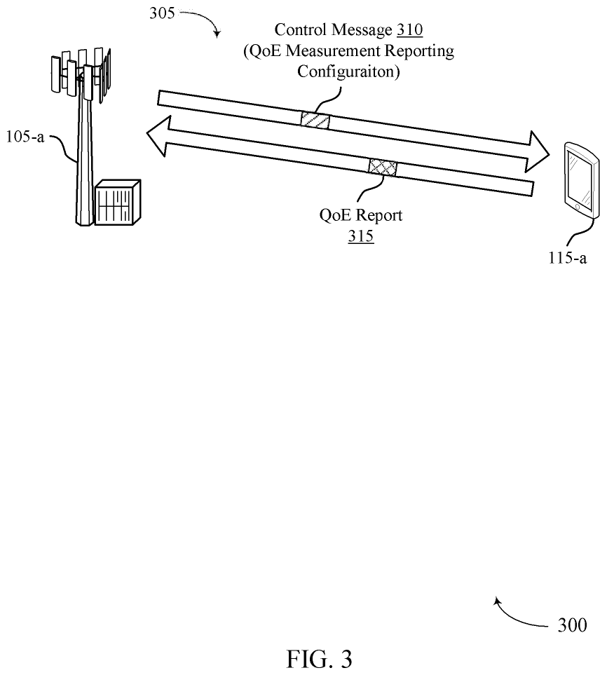

FIG. 3 illustrates an example of a wireless communications system 300 that supports techniques for QoE measurement and reporting in idle and inactive states in accordance with one or more aspects of the present disclosure. In some examples, aspects of the wireless communications system 300 may implement, or be implemented by, aspects of the wireless communications system 100, the network architecture 200, or both. In particular, the wireless communications system 300 may support QoE measurement and reporting configurations which enable a UE 115-a to perform (and/or report) QoE measurements while operating in an idle or inactive state, as described herein.

The wireless communications system 300 may include a network entity 105-a and a UE 115-a, which may be examples of network entities 105 and UEs 115 as described with reference to FIG. 1. The UE 115-a may communicate with the network entity 105-a using communication link 305, which may be an example of an NR or LTE link between the UE 115-a and the network entity 105-a. In some cases, the communication link 305 between the UE 115-a and the network entity 105-a may include an example of an access link (e.g., Uu link) which may include a bi-directional link that enables both uplink and downlink communication. For example, the UE 115-a may transmit uplink signals, such as uplink control signals or uplink data signals, to one or more components of the network entity 105-a using the communication link 305, and one or more components of the network entity 105-a may transmit downlink signals, such as downlink control signals or downlink data signals, to the UE 115-a using the communication link 305.

The UE 115-a and the network entity 105-a of the wireless communications system 300 may support wireless communications for various service types, including augmented reality (AR) applications, mixed reality (MR) applications, multicast-broadcast services (MBS), and other service types (e.g., other service types supported by 3GPP TSG SA WG4 (SA4)). For example, the wireless communications system 300 may support new service types and existing service types defined or to be supported by SA4, combined with high mobility scenarios, such as high-speed trains.

In order to support various service types, and to facilitate improved wireless communications at the UE 115-a, the UE 115-a may be configured to report QoE measurements to the network entity 105-a. As compared to QOS metrics, which are associated with a relative quality of wireless communications at the network, QoE measurements are associated with a QoE of the application services provisioned over wireless communications to the UE 115-a, including, but not limited to, a BLER at the UE 115-a, a quality of streamed videos at the UE 115-a, a buffering delay at the UE 115-a, and playback delay. Additionally, or alternatively, QoE measurements may be associated with a performance of at least one application or operation executable by the UE 115-a.

In some aspects, the UE 115-a may perform QoE measurements, and report the QoE measurements to the network entity 105-a via a QoE report 315. A QoE report 315 may include QoE measurements which are decoded and identified by the network entity 105-a (e.g., “RAN-visible” or “RAN-aware” QoE parameters), as well as QoE measurements which are not decoded (e.g., not capable of being decoded) by the network entity 105-a but rather passed on to the MCE for processing (e.g., “RAN-invisible” or “RAN-unaware” QoE parameters). In other words, the UE 115-a may transmit a QoE report 315 that includes a container of RAN-invisible measurements/parameters, and a set of RAN-visible measurement/parameters outside of the container. In such cases, the network entity 105-a may be configured to decode the set of RAN-visible measurements outside of the container, and forward or relay the container including the RAN-invisible measurements to the MCE. In some aspects, the wireless communications system 300 may support RAN-visible parameters for additional service types (e.g., AR, MR, MBS) through coordination with UE application layer.

As noted previously herein, some wireless communications systems may only enable UEs 115 to perform and report QoE measurements while operating in an RRC connected state (e.g., RRC_CONNECTED). UEs 115 may also receive communications while operating in other states such as RRC idle and inactive states (e.g., RRC_IDLE, RRC_INACTIVE). For example, the UE 115-a may receive emergency broadcast messages while in an idle/inactive state. However, due to the fact that some conventional wireless communications systems only enable QoE reporting during a connected state, the UE 115-a may be unable to measure and/or report the degraded QoE experienced during the idle/inactive states, which may cause the UE 115-a to consistently receive poor QoE for services provided in the idle and inactive states.

Along with supporting the performance, reporting, or both of QoE measurements while a UE is in an idle or inactive state, techniques as described herein may beneficially support the use by a UE of different QoE measurement and reporting configurations when in different states (e.g., when in an idle or inactive state versus when in a connected state). The use of different QoE measurement and reporting configurations when in different states may be beneficial, for example, because utilizing the same QoE measurement and reporting configuration across all states may result in increased power consumption when in the idle/inactive states (e.g., due to using the same QoE measurement and reporting configuration also used in the connected state), thereby reducing the power saving benefits that may otherwise be associated with the idle and inactive states, and resulting in increased power consumption at the UE.

Further, the performance, reporting, or both of QoE measurements while a UE is in an idle or inactive state as described herein may provide additional or alternative benefits as compared to other types of measurements. For example, in some cases, a UE may perform minimization of drive test (MDT) measurements, known as logged measurement or logged MDT in 3GPP systems, while in an idle or inactive state, and may transmit the MDT measurements together with a QoE report after transitioning to the connected state. However, MDT measurements are associated with a different layer as QoE measurements and serve a different purpose than QoE measurements. In particular, QoE measurements may include upper layer measurements (e.g., application layer measurements), whereas MDT measurements may include lower layer measurements (e.g., PDCP, RLC, MAC, and physical layer measurements). Additionally, MDT measurements are primarily used for coverage optimization purposes (e.g., to improve coverage across a network), whereas QoE measurements are related to the relative quality of application services provisioned over wireless communications perceived or measured at the UE, and therefore may, for example, be used for encoding/decoding to verify or optimize encoder and decoder operations at the network entity (e.g., application server). As such, the performance, reporting, or both of QoE measurements while a UE is in an idle or inactive state as described herein may serve distinct purposes and provide distinct benefits as compared to other types of measurements and may enable the network to improve a quality of application services provisioned over wireless communications experienced to the UE while operating in the idle/inactive states in a way that may not be supported by such other types of measurements.

Accordingly, the wireless communications system 300 may support QoE measurement configurations (e.g., QoE measurement collection) in RRC_INACTIVE and RRC_IDLE states for various applications, including MBS and other broadcast services. In particular, aspects of the present disclosure may support alignment of existing radio related measurement and QoE reporting in the context of QoE measurement configurations usable for idle and inactive states. In other words, techniques described herein may enable the UE 115-a to be configured with QoE measurement and reporting configurations which enable the UE 115-a to perform QoE measurements during idle/inactive states, while simultaneously enabling the UE 115-a to reduce power consumption while operating in the idle/inactive states. Moreover, QoE measurement and reporting configurations described herein may enable the UE 115-a to transition to a connected state to transmit a QoE report 315 and/or transmit a QoE report 315 while operating in the idle/inactive state.

In some aspects, the UE 115-a may be configured with a single QoE measurement and reporting configuration that is usable for connected, idle, and inactive states, where parameters of the QoE measurement and reporting configuration (e.g., periodicity of QoE measurements and/or QoE measurements metrics) may be updated as the UE 115-a transitions between states, such as via RRC release messages which release the UE 115-a from the connected state to the idle/inactive state. In additional or alternative cases, the UE 115-a may be configured with separate QoE measurement and reporting configurations for the connected and idle/inactive states. In some cases, the UE 115-a may perform QoE measurements while in the idle/inactive state, and may store QoE measurements in memory until the UE 115-a transitions to the connected state and can send a QoE report 315 indicating stored measurements. QoE measurement and reporting configurations may include trigger conditions which cause the UE to transition from the idle/inactive state to the connected state to transmit a QoE report 315. For example, if a QoE measurement falls below a threshold while in the idle/inactive state, the UE 115-a may transition from the idle/inactive state to the connected state to report the declining QoE measurements experienced during the idle/inactive states.

Aspects of the present disclosure may support QoE reporting for dual connectivity (DC) modes at the UE 115-a (e.g., NR-DC), which may enable QoE reporting via secondary nodes (SNs) and in mobility scenarios. As such, aspects of the present disclosure may support QoE measurement configurations for QoE measurement reporting over main nodes (MNs) and SNs for NR-DC architectures, and which enable QoE measurement reporting over DC legs in order to maintain reporting continuity. In other words, aspects of the present disclosure may support RAN-visible QoE and radio related measurement configuration and reporting in NR-DC scenarios. In some cases, in the context of NR-DC, the UE 115-a may not be configured to perform QoE measurements separately for each leg. QoE measurement and reporting configurations described herein may specify the alignment of QoE measurements (including legacy QoE and RAN-visible QoE measurements) and radio related measurement in NR-DC. Moreover, QoE measurement and reporting configurations described herein may support continuity of legacy or conventional QoE measurements for streaming and application services during intra-5GC inter-RAT handover process.

Moreover, aspects of the present disclosure may support QoE measurement and reporting configurations for various service types defined or to be supported by SA4, such as AR, MR, and MBS. In particular, aspects of the present disclosure may enable the UE 115-a to report RAN-visible QoE parameters for additional service types, such as MBS services in idle and inactive states. QoE measurement and reporting configurations described herein may facilitate QoE measurement collection and reporting for all RRC states, such as QoE measurement collection (QMC) and reporting in RRC-INACTIVE and RRC_IDLE states for MBS.

For example, referring to the wireless communications system 300, the UE 115-a may receive a control message 310 from the network entity 105-a, where the control signaling indicates one or more QoE measurement and reporting configurations. In some implementations, the UE 115-a may receive the control message 310 while operating in a connected state. The control message 310 may include an RRC message (e.g., RRCReconfiguration message, RRCRelease message), a DCI message, a MAC-CE message, or any combination thereof. In some aspects, the UE 115-a may be configured with a single QoE measurement and reporting configuration (e.g., QoE measurement configuration) which is usable for all RRC states, or may be configured with multiple QoE measurement and reporting configurations which are associated with (e.g., usable for) different states.

For example, in some cases, the control message 310 may indicate or configure the UE 115-a with a single QoE measurement and reporting configuration which is usable for all RRC states. In other words, the control message 310 may indicate a single QoE measurement and reporting configuration that is usable for the connected state, the idle state, and the inactive state (e.g., QoE measurement and reporting configuration usable for MBS for all RRC states). In such cases, the control message 310 may include an RRCReconfiguration message, where the QoE measurement and reporting configuration is indicated via an OtherConfig field of the RRCReconfiguration message. In some aspects, the single QoE measurement and reporting configuration may be used for all RRC states for measurement and reporting of both RAN-visible and RAN-invisible QoE measurements.

In cases where the UE 115-a is configured with a single QoE measurement and reporting configuration for all states, the network entity 105-a may update the QoE measurement and reporting configuration as the UE 115-a transitions between states. For example, the network entity 105-a may release the UE 115-a from the connected state to the idle or inactive state via an RRCRelease message, where the RRCRelease message updates or adjusts one or more parameters of the QoE measurement and reporting configuration for the idle/inactive state. For instance, the RRCRelease message may reduce a QoE measurement periodicity or frequency and/or reduce QoE measurements metrics associated with the QoE measurement and reporting configuration so that the UE 115-a may reduce power consumption while operating in the idle/inactive state.

In additional or alternative implementations, the control message 310 may indicate or configure the UE 115-a with multiple QoE measurement and reporting configurations. For example, the control message 310 may indicate a first QoE measurement and reporting configuration usable during the connected state, and a second QoE measurement and reporting configuration usable during the idle state and/or inactive state. In this example, the UE 115-a may be configured to switch between QoE measurement and reporting configurations as the UE 115-a transitions between the connected and idle/inactive states. The respective QoE measurement and reporting configurations may be indicated via an OtherConfig field of the RRCReconfiguration message. As compared to implementations in which the UE 115-a is configured with a single QoE measurement and reporting configuration which is adjusted or updated as the UE 115-a transitions between states, configuring the UE 115-a with multiple QoE measurement and reporting configurations may prevent or reduce the need to update the QoE measurement and reporting configurations as the UE 115-a transitions between states.

In some cases, the first QoE measurement and reporting configuration associated with the connected state may cause the UE 115-a to transmit both RAN-visible and RAN-invisible QoE measurements when the UE 115-a is in the connected state (but separately for MBS in the connected state). Similarly, the second QoE measurement and reporting configuration associated with the idle/inactive state may cause the UE 115-a to transmit both RAN-visible and RAN-invisible QoE measurements when the UE 115-a is in the idle/inactive state. In some implementations, the network entity 105-a may update the respective QoE measurement and reporting configurations, such as via RRCRelease messages transmitted to the UE 115-a.

In some implementations, QoE measurement and reporting configurations (e.g., QoE measurement and reporting configurations for MBS in idle and inactive states) for both RAN-visible and RAN-invisible QoE measurements may be indicated in an RRCRelease message (e.g., control message 310). In cases where the UE 115-a expects but does not receive the RAN-visible QoE configuration in an RRCRelease, the UE 115-a may still consider itself to be configured with a RAN-visible QoE measurement and reporting configuration, or may consider itself not to be configured with a RAN-visible QoE measurement and reporting configuration. That is, in cases where the UE 115-a is released to the idle/inactive state via an RRCRelease message, but does not receive a QoE measurement and reporting configuration via the RRCRelease message, the UE 115-a may be configured to perform QoE reporting during the idle/inactive state using a previously-configured QoE measurement and reporting configuration, or may be configured to refrain from performing QoE reporting during the idle/inactive state based on the absence of a QoE measurement and reporting configuration within the RRCRelease message.

In some implementations, upon receiving an RRCRelease message (e.g., control message 310) which releases the UE 115-a from the connected state to the idle/inactive state, an Access Stratum (AS) of the UE 115-a may send the RRCRelease notification to the application (APP) layer of the UE 115-a. In such cases, QoE reporting may be paused, and QoE measurements (e.g., QoE reports 315) may be stored at the UE 115-a AS or APP layer until the UE 115-a returns to the connected state. In other words, the UE 115-a may be configured to perform QoE measurements while operating in the idle/inactive state, and may be configured to store the QoE measurements (e.g., in memory, AS, APP layer) until the UE 115-a transitions to the connected state and is able to transmit a QoE report 315 indicating the stored QoE measurements.

In some aspects, the control message 310 may indicate one or more trigger conditions associated with the QoE measurement and reporting configuration for reporting QoE measurements to the network. Stated differently, the UE 115-a may be configured with one or more trigger conditions (e.g., event-triggers) which, if satisfied, cause the UE 115-a to transition from the idle/inactive state to the connected state so that the UE 115-a can transmit a QoE report 315. Trigger conditions for transmitting QoE reports 315 and/or transitioning to the connected state may be based on any parameters or characteristics including, but not limited to, QoE measurements performed by the UE 115-a, a quantity of buffered data (e.g., quantity of stored QoE measurements). For example, in some cases, a trigger condition for transitioning to the connected state and transmitting a QoE report 315 may be satisfied if a quality of MBS service degrades below a threshold associated with the respective QoE measurement and reporting configuration. In other words, the UE 115-a may identify a satisfaction of a trigger condition for transitioning to the connected state if QoE measurements are less than or equal to a threshold. By way of another example, the UE 115-a may identify a satisfaction of a trigger condition if a buffered data volume (e.g., quantity of stored QoE measurements, QoE report 315 size) is greater than or equal to a threshold. In such cases, the thresholds associated with the trigger conditions may be configured (e.g., pre-configured) at the UE 115-a, indicated via the control message 310, or both.

To reduce power consumption at the UE 115-a while supporting timely reporting of QoE measurements (e.g., RAN-visible QoE measurements, RAN-invisible QoE measurements), the network entity 105-a may be configured to define trigger conditions for the QoE measurement and reporting configuration by performing RRC establishment or resume.

In some aspects, trigger conditions may be defined for certain service types, such as MBS (in particular, when RAN-visible QoE is configured at the UE 115-a for MBS). Moreover, in some implementations, the control message 310 may indicate separate sets of trigger conditions for RAN-visible and RAN-invisible QoE measurements. For example, in some implementations, the QoE measurement and reporting configuration indicated via the control message 310 may include a first set of trigger conditions for RAN-visible QoE measurements, and a second set of trigger conditions for RAN-invisible QoE measurements. In such cases, the UE 115-a may be configured to transition to the connected state and transmit a QoE report 315 if a trigger condition from either set of trigger conditions is satisfied.

Trigger conditions associated with the QoE measurement and reporting configuration (e.g., trigger conditions for QoE measurement reporting) may be provided from the MCE to the RAN component of the network entity 105-a, where the RAN component configures the UE 115-a with the QoE measurement and reporting configuration (e.g., RAN component transmits the QoE measurement and reporting configuration to the UE 115-a). For RAN-invisible QoE measurements, trigger conditions may be defined in the QoE configuration container (e.g., container for RAN-invisible measurements within a QoE report 315). Comparatively, trigger conditions for reporting of RAN-visible QoE measurements may be determined by the RAN component of the network entity 105-a and sent to the UE 115-a via the control message 310 (e.g., RRC message, RRCRelease, or OtherConfig in an RRCReconfiguration message).

In additional or alternative implementations, the trigger conditions associated with the QoE measurement and reporting configuration may be configured at the AS layer of the UE 115-a. In such cases, the AS layer may be configured to determine whether to trigger RRC establishment or resume when receiving data from application layer. Alternatively, the trigger conditions may be configured at the application layer of the UE 115-a, in which cases the application layer may be configured to determine whether to trigger RRC establishment or resume when receiving data from other layers.

In some implementations, the UE 115-a may change cells (e.g., perform cell reselection procedure) while operating in the idle/inactive state. In such cases, upon cell reselection at the UE 115-a, the AS of the UE 115-a may notify the application layer of the UE 115-a as to the identification of the new cell (e.g., indicate the new cell identifier (ID)). In such cases, the UE 115-a may be configured to store the new cell ID in memory/QoE report, and add the new cell ID to the next transmitted QoE report 315. In other words, upon transitioning to the connected state, the UE 115-a may be configured to transmit a QoE report 315 including stored QoE measurements to the new cell associated with the new cell ID.

In some aspects, techniques described herein may allow RRC establishment or resume for QoE measurements while the UE 115-a is operating in the idle state or the inactive state. Enabling RRC establishment or resume in the idle/inactive states may improve performance for the ongoing service (e.g., MBS service), including scheduler optimization for ongoing MBS services by sending RAN-visible QoE measurements. However, such techniques may result in more frequent QoE reports 315 transmitted by the UE 115-a, which may result in increased power consumption at the UE 115-a.

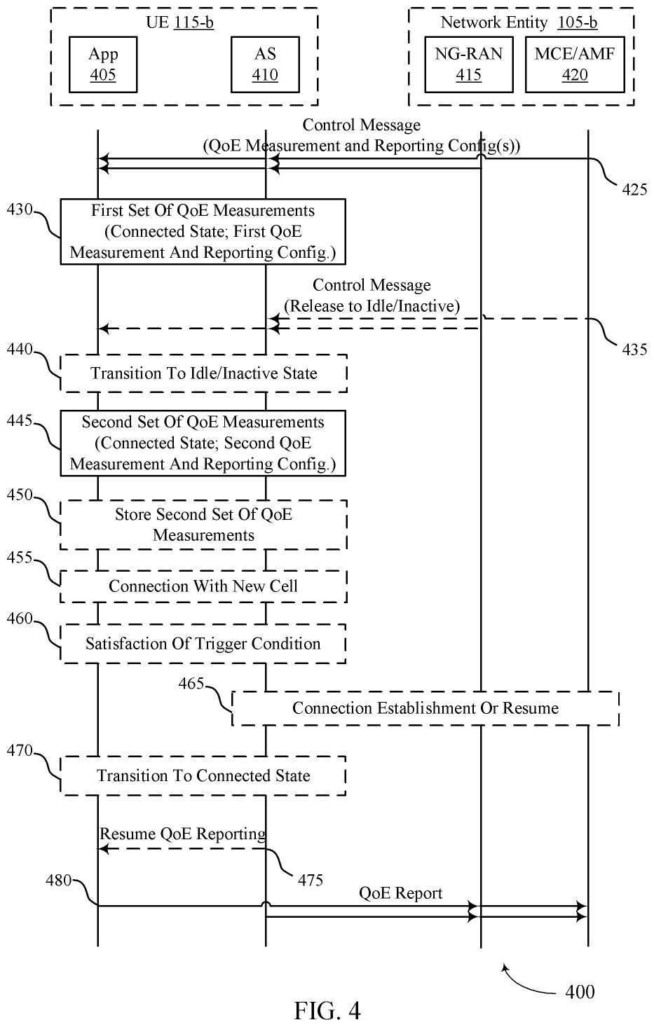

Various aspects of the QoE measurement and reporting configuration described herein, including trigger conditions, including Global Cell ID (GCI) in the QoE report after cell reselection procedures, and RRC establishment/resume, will be described in further detail herein with respect to FIG. 4.

In some aspects, a QoE measurement and reporting configuration usable by the UE 115-a during the inactive state (e.g., RRC_INACTIVE) may include or define unified access control (UAC)-based RRC establishment or resume for reporting QoE measurements. For example, the RRC layer of the UE 115-a may set the Access Category value to “8” or another reserved value (e.g., values 3-10), and the UE 115-a may use the Access Identity received from the NAS layer or RRC layer to request the connection resume for reporting QoE measurements (e.g., connection resume for transmitting QoE reports 315). In this example, in Msg3 of a random access procedure (e.g., RRCResumeRequest or RRCResumeRequest1), the UE 115-a may be configured to set a new cause value (e.g., QoE-data) as ResumeCause. The new ResumeCause value may be used by network entity 105-a in overload scenarios for access control. Moreover, when network entity 105-a receives the cause value as “QoE-data,” the network entity 105-a may be configured to setup a signaling radio bearer (SRB) (e.g., SRB4) during the resume procedure, where the SRB will be used by the UE 115-a for transmitting QoE reports 315.

Additionally, or alternatively, the UE 115-a may be configured to utilize the existing cause value for RRC resume in RRCResumeRequest or RRCResumeRequest1 (e.g., MO-data) as the resume cause. In such cases, the UE 115-a may indicate the availability of QoE data (e.g., stored QoE measurements awaiting reporting via a QoE report 315) in Msg5 of the random access procedure (e.g., RRCResumeComplete). Upon receiving the indication (e.g., via Msg5), the network entity 105-a may be configured to setup an SRB (e.g., SRB4) for the transmission/retrieval of the stored QoE measurements (e.g., setup SRB4 for QoE reports 315). In some aspects, if RRC resume is performed at a different network entity 105 other than configuring network entity 105-a, the new network entity 105-a may be configured to retrieve UE 115-a context information (including the QoE configuration(s)) from the previous network entity 105-a.

In some aspects, the wireless communications system 300 may support techniques for configuring an SRB (e.g., SRB4) for small data transmissions carrying QoE measurements (e.g., set sdt-SRB4-Indication-r18 ENUMERATED for small data transmission carrying QoE measurements, at least for RAN-visible QoE measurements). For example, in some implementations, SRB4 may not be suspended and/or deactivated once UE 115-a goes to the inactive state.

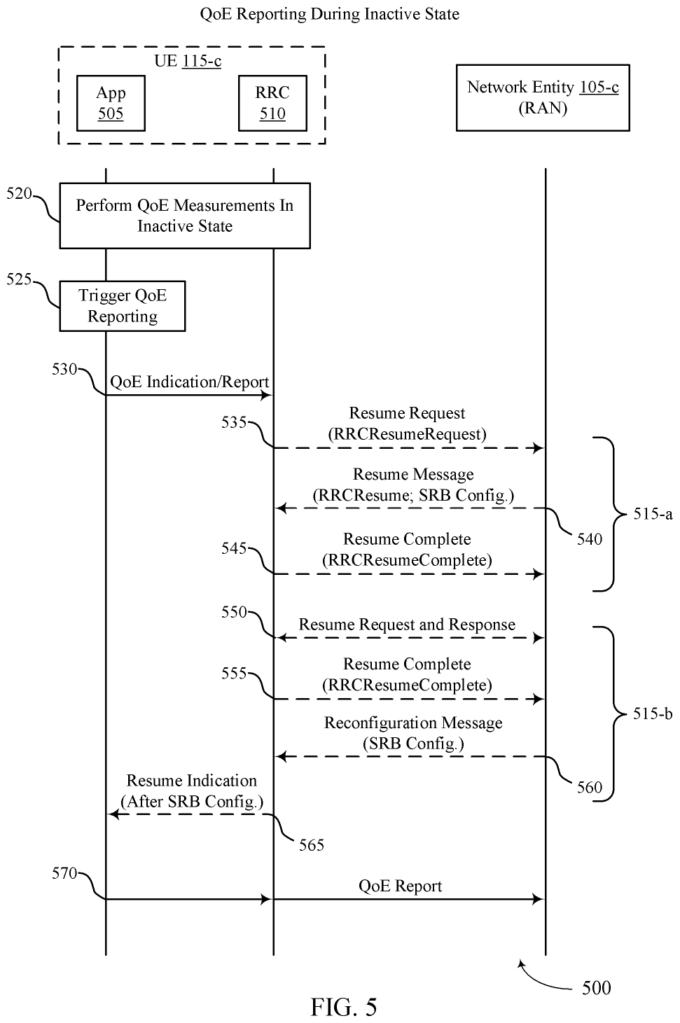

Techniques associated with QoE reporting during the inactive state (e.g., RRC_INACTIVE), including RRC establishment/resume and establishment of SRB (e.g., SRB4) for QoE reporting, will be described in further detail herein with respect to FIG. 5.

In some aspects, a QoE measurement and reporting configuration usable by the UE 115-a during the idle state (e.g., RRC_IDLE) may include or define UAC-based RRC establishment for reporting QoE measurements (e.g., for transmitting QoE reports 315). For example, the UE 115-a may set the Access Category value to “8” or another reserved value (e.g., values 3-10). In this example, in Msg3 of a random access procedure (e.g., RRCSetupRequest), the UE 115-a may be configured to set a new cause value (e.g., QoE-data) as EstablishmentCause, where the new EstablishmentCause value can be used by network entity 105-a in overload scenarios for access control. Moreover, when the network entity 105-a receives the cause value as “QoE-data,” the network entity 105-a may be configured to setup an SRB (e.g., SRB4) during the RRCSetup procedure, where the SRB will be used by the UE 115-a for transmitting QoE reports 315.

Additionally, or alternatively, the UE 115-a may be configured to use the existing cause value for RRC establishment in RRCSetupRequest (e.g., MO-data) as the establishment cause and indicate. In such cases, the UE 115-a may indicate the availability of QoE data in Msg5 of a random access procedure (e.g., RRCSetupComplete). Upon receiving the indication (e.g., via Msg5), the network entity 105-a may be configured to setup an SRB (e.g., SRB4) for the transmission/retrieval of the stored QoE measurements (e.g., setup SRB4 for QoE reports 315). During RRC connection establishment, QoE context information (including the respective QoE configuration usable by the UE 115-a) may be transferred to NG-RAN in the initial context setup request message by the AMF.

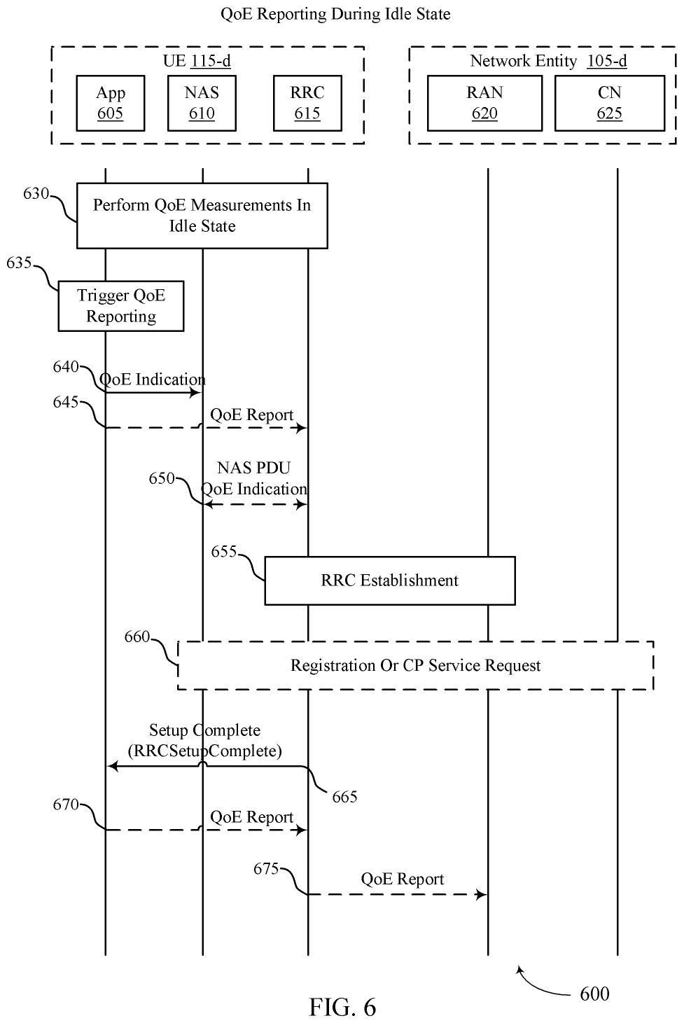

Techniques associated with QoE reporting during the idle state (e.g., RRC_IDLE), including RRC establishment/resume and establishment of SRB (e.g., SRB4) for QoE reporting, will be described in further detail herein with respect to FIG. 6.

Techniques described herein may enable the UE 115-a to perform QoE measurements while operating in an idle state, an inactive state, or both. As such, techniques described herein may enable the UE 115-a to inform the network (e.g., network entity 105-a) as to a relative quality of application services provisioned over wireless communications received at the UE 115-a during the idle and inactive states, (e.g. a relative quality of emergency broadcast messages). As such, aspects of the present disclosure may enable the network to adjust parameters of wireless communications and application server to improve a relative quality of application services (e.g., at the application server) and/or scheduler (e.g., at the network entity 105-a or gNB) during the idle and inactive states. In this regard, aspects of the present disclosure may facilitate improved coordination between the UE 115-a and the network, and improve an efficiency and reliability of application services provisioned over wireless communications received by the UE 115-a during inactive and idle states.

FIG. 4 illustrates an example of a process flow 400 that supports techniques for QoE measurement and reporting in idle and inactive states in accordance with one or more aspects of the present disclosure. In some examples, aspects of the process flow 400 may implement, or be implemented by, aspects of the wireless communications system 100, the network architecture 200, the wireless communications system 300, or any combination thereof. In particular, the process flow 400 illustrates a QoE measurement and reporting configuration which enables a UE 115-b to perform QoE measurements while operating in an idle or inactive state, as described with reference to FIGS. 1-3, among other aspects.

The process flow 400 may include a UE 115-b and a network entity 105-b, which may be examples of UEs 115 and network entities 105 as described with reference to FIGS. 1-3. For example, the UE 115-b and the network entity 105-b illustrated in FIG. 4 may be examples of the UE 115-a and network entity 105-a, respectively, as illustrated in FIG. 3. As shown in FIG. 4, the process flow 400 illustrates signaling not only between the UE 115-b and the network entity 105-b, but between various layers and components of the UE 115-b and the network entity 105-b. For example, as shown in FIG. 4, the UE 115-b may include an application 405 and an AS 410. Similarly, the network entity 105-b may include a RAN component 415 and an MCE/AMF 420.

In some examples, the operations illustrated in process flow 400 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 425, the UE 115-b may receive a control message from the network entity 105-b. In some aspects, the control message may indicate one or more QoE measurement and reporting configurations usable by the UE 115-b. QoE measurement and reporting configurations may include rules, conditions, and other parameters for performing QoE measurements at the UE 115-b, transmitting QoE reports, or both. The control message may include, but is not limited to, RRC signaling, synchronization signal block (SSB) signaling, system information signaling, and the like.

For example, in some cases, the control message may indicate a single QoE measurement and reporting configuration (e.g., for use when the UE 115-b is in the connected state) but which may be updated such that modified (and hence different) QoE measurement and reporting configurations may be used for one or more other states (e.g., the UE 115-b may use a modified configuration when in the idle or inactive state). In such cases, the QoE measurement and reporting configuration may be updated or modified as the UE 115-b transitions between different states, such that the UE 115-b effectively utilizes different “versions” of the QoE measurement and reporting configuration with different sets of parameters while operating in the respective states. By way of another example, in other cases, the control message may indicate a first QoE measurement and reporting configuration that is usable during the connected state, and a second QoE measurement and reporting configuration that is usable during the idle state and/or inactive state.

In some aspects, the control message may indicate one or more additional parameters or characteristics associated with the respective QoE measurement and reporting configuration(s). For example, in some cases, the control message may indicate one or more trigger conditions for QoE reporting. The trigger conditions may include rules or conditions which, when satisfied, cause the UE 115-b to transmit a QoE report. In particular, the trigger conditions, when satisfied, may cause the UE 115-b to transition from the idle/inactive state to the connected state in order to transmit a QoE report. As will be described in further detail herein, trigger conditions for QoE reporting may be associated with a relative quality of QoE measurements performed by the UE 115-b, a quantity of QoE measurements stored/buffered in memory, a service type associated with the UE 115-b, or any combination thereof.

At 430, while operating in the connected state, the UE 115-b may perform a first set of QoE measurements in accordance with a first QoE measurement and reporting configuration associated with the connected state. In this regard, the UE 115-b may perform the QoE measurements at 430 in accordance with a QoE measurement and reporting configuration indicated via the control message at 425. The QoE measurements may include, but are not limited to, BLER measurements, quality measurements, buffer delay measurements, or any combination thereof. The QoE measurements may be associated with an upper layer (e.g., application layer measurements). The QoE measurements may include RAN-visible QoE measurements (e.g., QoE measurements capable of being decoded by the network entity 105-b), RAN-invisible QoE measurements (e.g., QoE measurements that are not capable of being decoded by the network entity 105-b), or both.

In some implementations, the first set of QoE measurements may be transmitted to the network entity 105-b at 430. Additionally, or alternatively, as will be described in further detail herein, the first set of QoE measurements may be stored in memory, and transmitted at a later time.

At 435, the UE 115-b may receive, from the network entity 105-b, an additional control message instructing the UE 115-b to transition from the connected state to the idle state or the inactive state. For example, the UE 115-b may receive an RRCRelease message which releases the UE 115-b from the connected state to the idle or inactive state. The UE 115-b may receive the additional control message at 435 based on receiving the control message at 425, performing the first set of QoE measurements at 430, or both.

In some implementations, the additional control message at 435 may update or modify a QoE measurement and reporting configuration usable by the UE 115-b during the idle/inactive state, indicate a new QoE measurement and reporting configuration usable by the UE 115-b during the idle/inactive state, or both. That is, the additional control message may indicate or update QoE measurement and reporting configuration(s) associated with RAN-visible QoE reporting, RAN-invisible QoE reporting (e.g., for MBS in idle or inactive states), or both.

For example, in cases where the UE 115-b is configured with a single QoE measurement and reporting configuration (e.g., first QoE measurement and reporting configuration), the additional control message may update or modify one or more parameters associated with the first QoE measurement and reporting configuration. In particular, the additional control message may cause the UE 115-b to update one or more parameters in order to generate a modified version of the first QoE measurement and reporting configuration in order to reduce a power consumption of the first QoE measurement and reporting configuration used during the inactive/idle state. Parameters of QoE measurement and reporting configurations which may be modified or updated may include, but are not limited to, a periodicity/frequency of QoE measurements, QoE measurement metrics, a type of QoE measurements, a quality or accuracy of QoE measurements, or any combination thereof. For instance, the additional control message may reduce a periodicity or frequency of QoE measurements that are performed in accordance with the first QoE measurement and reporting configuration in order to reduce power consumption at the UE 115-b.

By way of another example, in some cases, the control message may indicate a new QoE measurement and reporting configuration that is to be used by the UE 115-b in the idle/inactive state. For instance, the control message at 425 may indicate the first QoE measurement and reporting configuration associated with the connected state, and the additional control message at 435 may indicate a second QoE measurement and reporting configuration associated with the idle/inactive state. In some implementations, the additional control message at 435 may additionally or alternatively indicate one or more parameters associated with QoE measurement and reporting configurations, such as trigger conditions for QoE reporting.

At 440, the UE 115-b may transition from the connected state to the idle or inactive state. In particular, the UE 115-b may transition to the idle/inactive state in response to receiving the additional control message at 435. Upon transitioning to the idle/inactive state, the application 405 of the UE 115-b may continue to perform QoE measurements, but QoE reporting may be paused or suspended while the UE 115-b is in the idle/inactive state.

At 445, while operating in the idle or inactive state, the UE 115-b may perform a second set of QoE measurements in accordance with a second QoE measurement and reporting configuration associated with the idle/inactive state. In this regard, the UE 115-b may perform the QoE measurements at 445 in accordance with a QoE measurement and reporting configuration indicated via the control message at 425, via the additional control message at 435, or both. The QoE measurements may include, but are not limited to, BLER measurements, quality measurements, buffer delay measurements, or any combination thereof. The QoE measurements may be associated with an upper layer (e.g., application layer measurements). The QoE measurements may include RAN-visible QoE measurements (e.g., QoE measurements capable of being decoded by the network entity 105-b), RAN-invisible QoE measurements (e.g., QoE measurements that are not capable of being decoded by the network entity 105-b), or both

The first QoE measurement and reporting configuration utilized at 430 and the second QoE measurement and reporting configuration utilized at 445 may be associated with different parameters for QoE reporting (e.g., different measurement periodicities of QoE measurements, different QoE reporting periodicities, different QoE measurement quantities, different QoE measurement qualities). Moreover, in some aspects, the second QoE measurement and reporting configuration may be associated with a lower power consumption as compared to the first QoE measurement and reporting configuration. For example, the first QoE measurement and reporting configuration may be associated with a first power consumption at the UE 115-b, and the second QoE measurement and reporting configuration may be associated with a second power consumption at the UE 115-b that is less than the first power consumption.

As noted previously herein, the UE 115-b may be configured with a same QoE measurement and reporting configuration usable for the connected, idle, or inactive states, or with separate QoE measurement and reporting configurations associated with the respective states. For example, in cases where the UE 115-b is configured with a single QoE measurement and reporting configuration, the UE 115-b may update or modify the QoE measurement and reporting configuration upon transitioning between states. For instance, the control message may modify one or more parameters of the first QoE measurement and reporting configuration upon releasing the UE 115-b to the idle/inactive state. In such cases, the second QoE measurement and reporting configuration utilized at 445 may include a modified version of the first QoE measurement and reporting configuration. Additionally, or alternatively, the second QoE measurement and reporting configuration may include a separate QoE measurement and reporting configuration from the first QoE measurement and reporting configuration, where the second QoE measurement and reporting configuration is associated with (e.g., designated for) the idle and/or inactive state.

As noted previously herein, the second QoE measurement and reporting configuration may be associated with RAN-visible QoE information (e.g., RAN-aware QoE information), RAN-invisible QoE information (e.g., RAN-non-aware QoE information), or both. That is, the second set of QoE measurements may include RAN-visible QoE measurements (e.g., QoE measurements capable of being decoded by the network entity 105-b), RAN-invisible QoE measurements (e.g., QoE measurements that are not capable of being decoded by the network entity 105-b), or both.

At 450, the UE 115-b may store (e.g., buffer) at least the second quantity of QoE measurements in memory while operating in the idle/inactive state. In particular, the UE 115-b may store at least the second set of QoE measurements at 450 in accordance with the second QoE measurement and reporting configuration. In cases where the first set of QoE measurements performed at 430 had not yet been transmitted to the network entity 105-b, the first set of QoE measurements may additionally be stored in memory so that they may be transmitted in the next QoE report. In such cases where the memory includes QoE measurements performed during the connected state and QoE measurements performed during the idle/inactive state, each respective QoE measurement may be stored with an identifier indicating which state the respective QoE measurement was performed during.

At 455, the UE 115-b may establish a wireless connection with a new cell while operating in the idle or inactive state. That is, the UE 115-b may have been previously communicating with a first cell, and may establish a wireless connection with a second cell different from the first cell. In some cases, the first and second cells may be associated with (e.g., supported by) the network entity 105-b, or different network entities 105. Upon establishing the connection with the second cell, the AS 410 may transmit or indicate a cell identifier (ID) associated with the second cell to the application 405. The UE 115-b may store the cell ID of the second cell in memory, such that the cell ID may be included within QoE reports. That is, the UE 115-b may be configured to transmit subsequent QoE reports to the first cell, the second cell, or both.

At 460, the UE 115-b may identify a satisfaction of a trigger condition for QoE reporting while operating in the idle/inactive state. That is, the UE 115-b may identify a satisfaction of a trigger condition for transmitting a QoE report, for transitioning to the connected state, or both. In this regard, the UE 115-b may identify a satisfaction of a trigger condition which was indicated or configured via the control message at 425, the additional control message at 435, or both.

Trigger conditions for QoE reporting may be associated with a relative quality of QoE measurements performed by the UE 115-b, a quantity of QoE measurements stored/buffered in memory, a service type associated with the UE 115-b, or any combination thereof. For example, the UE 115-b may identify a satisfaction of the trigger condition in cases where the UE 115-b is configured to perform MBS service (e.g., when RAN-visible QoE is configured at the UE 115-b for MBS). By way of another example, the UE 115-b may identify a satisfaction of the trigger condition in cases where the buffered data volume (e.g., quantity of QoE measurements stored in memory, QoE report size) is greater than or equal to some threshold. By way of yet another example, the UE 115-b may identify a satisfaction of the trigger condition in cases where at least one QoE measurement of the second set of QoE measurements performed at 445 is worse than a threshold (e.g., QoE measurement less than or equal to a QoE threshold). In some aspects, thresholds for trigger conditions may be indicated via the control message at 425, the additional control message at 435, configured (e.g., pre-configured) at the UE 115-a, or any combination thereof.

As noted previously herein, in some implementations, the UE 115-b may be capable of transmitting QoE reports while operating in the inactive state. In such cases, the UE 115-b may be configured to transmit a QoE report to the network entity 105-b while in the inactive state upon identifying the satisfaction of the trigger condition at 460. For example, in some cases, the network entity 105-b may indicate or configure (e.g., via the control message at 425, via the additional control message at 435) an SRB (SRB4) for QoE reporting, and the UE 115-b and the network entity 105-b may be configured to maintain the SRB in an activated state while the UE 115-b operates in the inactive state. In such cases, the UE 115-b may be configured to transmit a QoE report via the configured and activated SRB while operating in the inactive state.

Conversely, in cases where the UE 115-b operates in the idle state, the UE 115-b may be unable to transmit QoE report while in the idle state, as DRBs and SRBs may be unable to be maintained in an activated state while in the idle state (e.g., the UE 115-b may release DRBs and SRBs in the RRC_IDLE state). In such cases, the process flow 400 may proceed to 465.

At 465, the UE 115-b and the network entity 105-b may establish (e.g., reestablish) or resume a connection. In other words, the UE 115-b and the network entity 105-b may perform RRC connection establishment or RRC connection resume. In some aspects, the UE 115-b and the network entity 105-b may establish or resume a connection at 465 based on the satisfaction of the trigger condition at 460.

In some cases, the UE 115-b may transmit a request to establish or resume a wireless connection with the network entity 105-b while operating in the idle/inactive state at 465. In other words, the UE 115-b may transmit an RRCResume request message (e.g., RRCResumeRequest, RRCResumeRequest1). Additionally, the network entity 105-b may transmit an acknowledgment message in response to the request indicating that the RRC connection establishment or RRC connection resume has been completed (e.g., RRCResumeComplete message). In some cases, as will be described in further detail with respect to FIGS. 5-6, the network entity 105-b may indicate or configure an SRB (e.g., SRB4) for QoE reporting as part of the RRC connection establishment/resume at 465. In such cases, the indicated/configured SRB may be used to transmit subsequent QoE reports.

In some aspects, as part of establishing/resuming a wireless connection with the network entity 105-b at 465, the UE 115-b may perform QoE context retrieval and/or update a QoE measurement and reporting configuration. For example, in some cases, the network entity 105-b may update a QoE measurement and reporting configuration that will be used for the connected state, the idle/inactive states, or both.

At 470, the UE 115-b may transition from the idle/inactive state to the connected state. In particular, the UE 115-b may transition to the connected state at 470 based on establishing the connection with the new cell at 455, identifying the satisfaction of the trigger condition at 460, establishing or resuming the connection with the network entity 105-b at 465, or any combination thereof. For example, the UE 115-b may transmit a request to establish or resume a wireless communication with the network entity 105-b at 465, and may transition to the connected state at 470 based on transmitting the request (e.g., based on receiving a message in response to the request).

At 475, the AS 410 may indicate, to the application 405, for the UE 115-b to resume QoE reporting, and/or to update a QoE measurement and reporting configuration (if applicable). The AS 410 may indicate for the UE 115-b to resume QoE reporting based on establishing or resuming the connection with the network entity 105-b at 465, transitioning to the connected state at 470, or both.

At 480, the UE 115-b may transmit a QoE report to the network entity 105-b, where the QoE report includes at least the second set of QoE measurements performed in the idle/inactive state at 445, and which were stored in memory at 450. In some cases, the QoE report may additionally include the first set of QoE measurements performed during the connected state at 430. The UE 115-b may transmit the QoE report in accordance with the first QoE measurement and reporting configuration, the second QoE measurement and reporting configuration, or both. In cases where the UE 115-b establishes a connection with a second cell at 455, the QoE report may include or indicate a cell ID associated with the second cell. That is, the UE 115-b may transmit the QoE report to the first cell, the second cell, or both.

Moreover, the UE 115-b may transmit the QoE report at 480 based on identifying the satisfaction of the trigger condition at 460, establishing or resuming the connection with the network entity 105-b at 465, transitioning to the connected state at 470, resuming QoE reporting at 475, or any combination thereof. For example, in some cases, the network entity 105-b may configure or indicate an SRB (e.g., SRB4) as part of establishing/resuming a wireless connection with the UE 115-b at 465 (e.g., in response to a request from the UE 115-b). In such cases, the UE 115-b may transmit the QoE report to the network entity 105-b via the SRB that was indicated/configured at 465.

Techniques described herein may enable the UE 115-b to perform QoE measurements while operating in an idle state, an inactive state, or both. As such, techniques described herein may enable the UE 115-b to inform the network as to a relative quality of wireless communications received at the UE 115 during the idle and inactive states, including a relative quality of emergency broadcast messages. As such, aspects of the present disclosure may enable the network to adjust parameters of wireless communications to improve a relative quality of such wireless communications received by the UE 115-b during the idle and inactive states. In this regard, aspects of the present disclosure may facilitate improved coordination between the UE 115-b and the network entity 105-b, and improve an efficiency and reliability of application services provisioned over wireless communications received by the UE 115-b during inactive and idle states.

FIG. 5 illustrates an example of a process flow 500 that supports techniques for QoE measurement and reporting in idle and inactive states in accordance with one or more aspects of the present disclosure. In some examples, aspects of the process flow 500 may implement, or be implemented by, aspects of the wireless communications system 100, the network architecture 200, the wireless communications system 300, the process flow 400, or any combination thereof. In particular, the process flow 500 illustrates a QoE measurement and reporting configuration which enables a UE 115-c to perform QoE measurements while operating in an idle or inactive state, as described with reference to FIGS. 1-3, among other aspects.

The process flow 500 may include a UE 115-c and a network entity 105-c, which may be examples of UEs 115 and network entities 105 as described with reference to FIGS. 1-4. For example, the UE 115-c and the network entity 105-c illustrated in FIG. 5 may be examples of the UE 115-a and network entity 105-a illustrated in FIG. 3, or the UE 115-b and the network entity 105-b illustrated in FIG. 4. As shown in FIG. 5, the process flow 500 illustrates signaling not only between the UE 115-c and the network entity 105-c, but between various layers and components of the UE 115-c and the network entity 105-c. For example, as shown in FIG. 5, the UE 115-c may include an application 505 and an RRC component 510.

In some examples, the operations illustrated in process flow 500 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 520, the UE 115-c may be configured to perform QoE measurements while operating in the inactive state. For example, as described with reference to 445 of process flow 400 illustrated in FIG. 4, the UE 115-c may be configured to perform QoE measurements in accordance with a QoE measurement and reporting configuration associated with the inactive state.

At 525, the UE 115-c (e.g., the application 505 of the UE 115-c) may trigger QoE reporting. In particular, the UE 115-c may trigger QoE reporting based on the measurements performed at 520. For example, as described with reference to 460 of process flow 400 illustrated in FIG. 4, the UE 115-c may be configured to trigger QoE reporting based on identifying a satisfaction of a trigger condition for QoE reporting.

At 530, the application 505 of the UE 115-c may transmit a QoE indication (e.g., QoE reporting indication) to the RRC component 510. The application 505 may transmit the indication at 530 based on performing the QoE measurements at 520, triggering the QoE reporting at 530, or both.

At 535, the UE 115-c may transmit a request to establish or resume wireless communications with the network entity 105-c (e.g., RRCResumeRequest, RRCResumeRequest1). The UE 115-c may transmit the request at 535 based on performing the QoE measurements at 520, triggering the QoE reporting at 525, transmitting the QoE indication at 530, or any combination thereof.

In some aspects, a QoE measurement and reporting configuration usable by the UE 115-c during the inactive state (e.g., RRC_INACTIVE) may include or define UAC-based RRC establishment or resume for reporting QoE measurements. For example, the RRC layer of the UE 115-c may sets the Access Category value to “8” or another reserved value (e.g., values 3-10), and the UE 115-c may use the Access Identity received from the NAS layer or RRC layer to request the connection resume for reporting QoE measurements (e.g., connection resume for transmitting QoE reports 315). For example, in the resume request at 535 (e.g., in Msg3 of a random access procedure), the UE 115-c may be configured to set a new cause value (e.g., QoE-data) as ResumeCause. The new ResumeCause value may be used by network entity 105-c in overload scenarios for access control.

At 540, the UE 115-c may receive, from the network entity 105-c, a resume message (e.g., RRCResume) in response to the resume request at 535. In other words, the network entity 105-c may acknowledge the request at 535, and indicate a wireless communication link may be resumed. In some aspects, the network entity 105-c may indicate or configure an SRB (e.g., SRB4) via the resume message at 540. For example, when network entity 105-c receives the cause value of the resume request as “QoE-data,” the network entity 105-c may be configured to setup an SRB (e.g., SRB4) during the resume procedure, where the SRB will be used by the UE 115-c for transmitting QoE reports.

At 545, the UE 115-c may transmit a resume complete message (e.g., RRCResumeComplete) to the network entity 105-c. The UE 115-c may transmit the resume complete message at 545 based on transmitting the request at 535, and/or in response to receiving the resume message at 540.

The set of signals 515-a illustrated in FIG. 5 illustrate a first implementation in which the UE 115-c utilizes reserved values of an Access Category to establish or resume a wireless connection for QoE reporting. In additional or alternative implementations, the UE 115-a may be configured to utilize the existing cause value for RRC resume in RRCResumeRequest or RRCResumeRequest1 (e.g., MO-data) as the resume cause, as illustrated via the set of signals 515-b. As such, the respective sets of signals 515-a, 515-b may be viewed as alternative signaling procedures used to establish or resume wireless communications for QoE reporting.

At 550, the UE 115-c and the network entity 105-c may exchange resume request message and resume response messages. The UE 115-c and the network entity 105-c may exchange the messages at 550 based on performing the QoE measurements at 520, triggering the QoE reporting at 525, transmitting the QoE indication at 530, or any combination thereof.

At 555, the UE 115-c may transmit a resume complete message (e.g., RRCResumeComplete message) to the network entity 105-c based on the signaling at 550. In some cases, the resume complete message may indicate QoE data availability. In other words, the resume complete message may indicate that the UE 115-c has QoE measurements to report via a QoE report. In this example, the UE 115-c may indicate the availability of QoE data (e.g., stored QoE measurements awaiting reporting via a QoE report) in Msg5 of the random access procedure (e.g., RRCResumeComplete). In this regard, the resume complete message may include an example of Msg5 of a random access procedure.

At 560, the UE 115-c may receive, from the network entity 105-c, a reconfiguration message (e.g., RRCReconfiguration) in response to the resume complete message at 555. In some aspects, the network entity 105-c may indicate or configure an SRB (e.g., SRB4) via the reconfiguration message at 560. For example, upon receiving the indication of the available QoE data via the resume complete message (e.g., via Msg5), the network entity 105-c may be configured to setup an SRB (e.g., SRB4) for the transmission/retrieval of the stored QoE measurements (e.g., setup SRB4 for QoE reports). In some aspects, if RRC resume is performed at a different network entity 105 other than configuring network entity 105-a, then new network entity 105 may be configured to retrieve UE 115-a context information (including the QoE configuration(s)) from the network entity 105-a.

After performing the signaling illustrated in the first set of signals 515-a or the second set of signals 515-b, the process flow 500 may proceed to 565.

At 565, the RRC component 510 may transmit a resume indication to the application 505 of the UE 115-c. In particular, the RRC component 510 may transmit the indication at 565 after the SRB (e.g., SRB4) is setup or configured via the first set of signals 515-a or the second set of signals 515-b.

At 570, the UE 115-c may transmit a QoE report to the network entity 105-c, where the QoE report includes the QoE measurements performed at 520. In particular, the UE 115-c may transmit the QoE report to the network entity 105-c via the SRB that was indicated/configured via the first set of signals 515-a or the second set of signals 515-b.

FIG. 6 illustrates an example of a process flow 600 that supports techniques for QoE measurement and reporting in idle and inactive states in accordance with one or more aspects of the present disclosure. In some examples, aspects of the process flow 600 may implement, or be implemented by, aspects of the wireless communications system 100, the network architecture 200, the wireless communications system 300, the process flow 400, the process flow 500, or any combination thereof. In particular, the process flow 600 illustrates a QoE measurement and reporting configuration which enables a UE 115-d to perform QoE measurements while operating in an idle or inactive state, as described with reference to FIGS. 1-5, among other aspects.

The process flow 600 may include a UE 115-d and a network entity 105-d, which may be examples of UEs 115 and network entities 105 as described with reference to FIGS. 1-5. For example, the UE 115-d and the network entity 105-d illustrated in FIG. 6 may be examples of the UE 115-a and network entity 105-a illustrated in FIG. 3, the UE 115-b and the network entity 105-b illustrated in FIG. 4, and/or the UE 115-c and the network entity 105-c illustrated in FIG. 5. As shown in FIG. 6, the process flow 600 illustrates signaling not only between the UE 115-d and the network entity 105-d, but between various layers and components of the UE 115-d and the network entity 105-d. For example, as shown in FIG. 6, the UE 115-d may include an application 605, a NAS component 610, and an RRC component 615. Similarly, the network entity 105-d may include a RAN component 620 and a CN 625.

In some examples, the operations illustrated in process flow 600 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 630, the UE 115-d may be configured to perform QoE measurements while operating in the idle state. For example, as described with reference to 445 of process flow 400 illustrated in FIG. 4, the UE 115-d may be configured to perform QoE measurements in accordance with a QoE measurement and reporting configuration associated with the idle state.

At 635, the UE 115-d (e.g., the application 605 of the UE 115-d) may trigger QoE reporting. In particular, the UE 115-d may trigger QoE reporting based on the measurements performed at 630. For example, as described with reference to 460 of process flow 400 illustrated in FIG. 4, the UE 115-d may be configured to trigger QoE reporting based on identifying a satisfaction of a trigger condition for QoE reporting.

At 640, the application 605 of the UE 115-d may transmit a QoE indication (e.g., QoE reporting indication) to the RRC component 615. The application 605 may transmit the indication at 640 based on performing the QoE measurements at 630, triggering the QoE reporting at 635, or both.

At 645, the application 605 of the UE 115-d may transmit a QoE report (e.g., QoE report including the QoE measurements performed at 630) to the RRC component 615 of the UE 115-d. In this regard, the application 605 may transmit the QoE report at 645 based on performing the QoE measurements at 630, triggering the QoE reporting at 635, transmitting the QoE indication at 640, or any combination thereof.

At 650, the NAS component 610 and the RRC component 615 may exchange signaling for a NAS packet data unit (PDU) connection for QoE reporting. The NAS component 610 and the RRC component 615 may exchange the signaling at 650 based on performing the QoE measurements at 630, triggering the QoE reporting at 635, receiving the QoE indication at 640, receiving the QoE report at 645, or any combination thereof.

At 655, the RRC component of the UE 115-d and the RAN component of the network entity 105-d may reestablish a wireless connection (e.g., perform RRC establishment). In some aspects, the QoE measurement and reporting configuration usable by the UE 115-d during the idle state (e.g., RRC_IDLE) may include or define UAC-based RRC establishment for reporting QoE measurements (e.g., for transmitting QoE reports). For example, during RRC establishment at 655, the UE 115-d may set the Access Category value to “8” or another reserved value (e.g., values 3-10). In this example, in Msg3 of a random access procedure (e.g., RRCSetupRequest), the UE 115-d may be configured to set a new cause value (e.g., QoE-data) as EstablishmentCause, where the new EstablishmentCause value can be used by network entity 105-d in overload scenarios for access control. Moreover, when the network entity 105-d receives the cause value as “QoE-data,” the network entity 105-d may be configured to setup an SRB (e.g., SRB4) during the RRCSetup procedure, where the SRB will be used by the UE 115-d for transmitting QoE reports.

Additionally, or alternatively, the UE 115-d may be configured to use the existing cause value for RRC establishment in RRCSetupRequest (e.g., MO-data) as the establishment cause and indicate. In such cases, the UE 115-d may indicate the availability of QoE data in Msg5 of a random access procedure (e.g., RRCSetupComplete). Upon receiving the indication (e.g., via Msg5), the network entity 105-d may be configured to setup an SRB (e.g., SRB4) for the transmission/retrieval of the stored QoE measurements (e.g., setup SRB4 for QoE reports). During RRC connection establishment, QoE context information (including the respective QoE configuration usable by the UE 115-d) may be transferred to NG-RAN in the initial context setup request message by the AMF.

At 660, the UE 115-d and the network entity 105-d may exchange signaling for registration or service request. In particular, the UE 115-d and the network entity 105-d may exchange the signaling at 660 based on establishing the RRC connection at 655. For example, in some cases, the UE 115-d and the network entity 105-d may exchange signaling for registration or CP service request without user plan resource establishment. Additionally, or alternatively, the UE 115-d and the network entity 105-d may exchange signaling for service request to activate user plane resource for MBS service.

At 665, the RRC component 615 of the UE 115-d may transmit a setup complete message (e.g., RRCSetupComplete) to the application 605 of the UE 115-d. The RRC component 615 may transmit the setup complete message at 615 based on establishing the RRC connection at 655, exchanging the signaling for the registration or service request at 660, or both.

At 670, the application 605 of the UE 115-d may transmit a QoE report (e.g., QoE report including the QoE measurements performed at 630) to the RRC component 615 of the UE 115-d. The application 605 may transmit the QoE report at 670 based on receiving the setup complete message at 665.

At 675, the UE 115-d may transmit a QoE report to the network entity 105-d, where the QoE report includes the QoE measurements performed at 630. In particular, the UE 115-d may transmit the QoE report to the network entity 105-d via the SRB that was indicated/configured via the RRC establishment at 655.

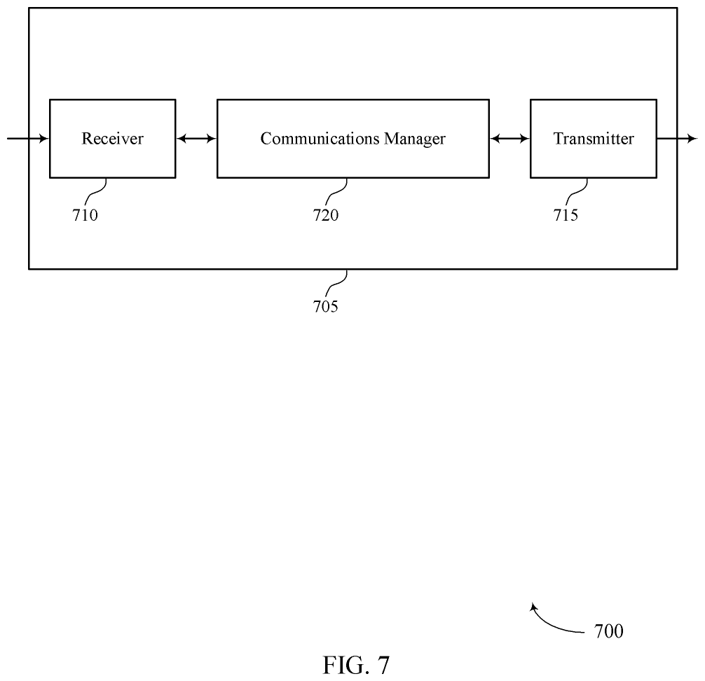

FIG. 7 shows a block diagram 700 of a device 705 that supports techniques for QoE measurement and reporting in idle and inactive states in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for QoE measurement and reporting in idle and inactive states). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for QoE measurement and reporting in idle and inactive states). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for QoE measurement and reporting in idle and inactive states as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for performing, while operating in a connected state, a first set of QoE measurements in accordance with a first QoE measurement and reporting configuration associated with the connected state. The communications manager 720 may be configured as or otherwise support a means for transitioning from the connected state to one of an idle state or an inactive state. The communications manager 720 may be configured as or otherwise support a means for performing, while operating in the idle state or the inactive state, a second set of QoE measurements in accordance with a second QoE measurement and reporting configuration associated with the idle state, the inactive state, or both, the second QoE measurement and reporting configuration different from the first QoE measurement and reporting configuration. The communications manager 720 may be configured as or otherwise support a means for transmitting, to a network entity, a QoE report including at least the second set of QoE measurements.

By including or configuring the communications manager 720 in accordance with examples as described herein, the device 705 (e.g., a processor controlling or otherwise coupled with the receiver 710, the transmitter 715, the communications manager 720, or a combination thereof) may support techniques which enable UEs 115 to perform QoE measurements while operating in an idle state, an inactive state, or both. As such, techniques described herein may enable UEs 115 to inform the network as to a relative quality of wireless communications received at the UE 115 during the idle and inactive states, including a relative quality of emergency broadcast messages. As such, aspects of the present disclosure may enable the network to adjust parameters of wireless communications to improve a relative quality of such wireless communications received by the UE 115 during the idle and inactive states. In this regard, aspects of the present disclosure may facilitate improved coordination between the UE 115 and the network, and improve an efficiency and reliability of application services provisioned over wireless communications received by the UE 115 during inactive and idle states.

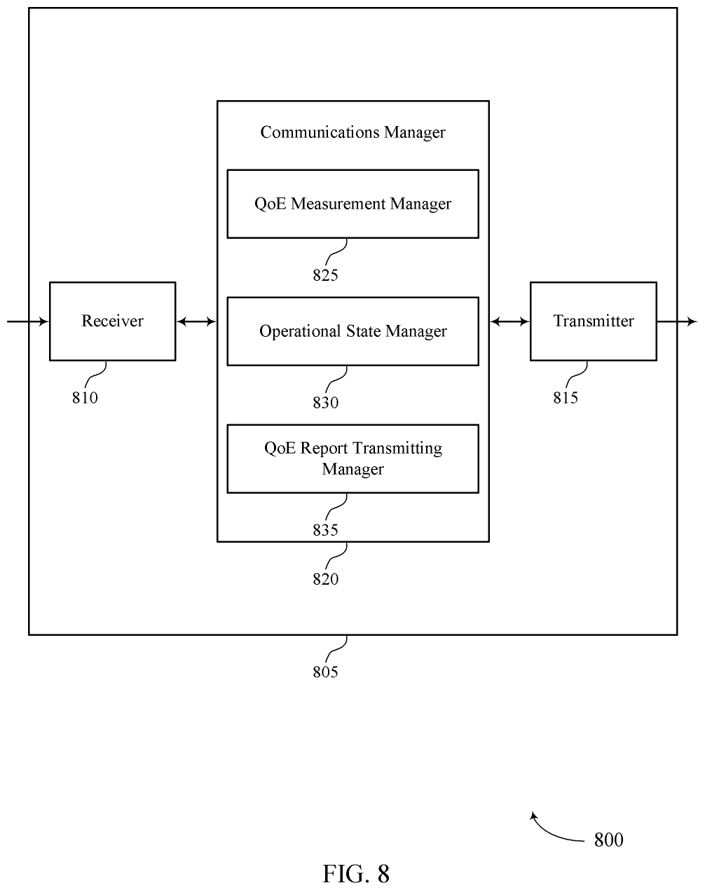

FIG. 8 shows a block diagram 800 of a device 805 that supports techniques for QoE measurement and reporting in idle and inactive states in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for QoE measurement and reporting in idle and inactive states). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for QoE measurement and reporting in idle and inactive states). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for QoE measurement and reporting in idle and inactive states as described herein. For example, the communications manager 820 may include a QoE measurement manager 825, an operational state manager 830, a QoE report transmitting manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The QoE measurement manager 825 may be configured as or otherwise support a means for performing, while operating in a connected state, a first set of QoE measurements in accordance with a first QoE measurement and reporting configuration associated with the connected state. The operational state manager 830 may be configured as or otherwise support a means for transitioning from the connected state to one of an idle state or an inactive state. The QoE measurement manager 825 may be configured as or otherwise support a means for performing, while operating in the idle state or the inactive state, a second set of QoE measurements in accordance with a second QoE measurement and reporting configuration associated with the idle state, the inactive state, or both, the second QoE measurement and reporting configuration different from the first QoE measurement and reporting configuration. The QoE report transmitting manager 835 may be configured as or otherwise support a means for transmitting, to a network entity, a QoE report including at least the second set of QoE measurements.

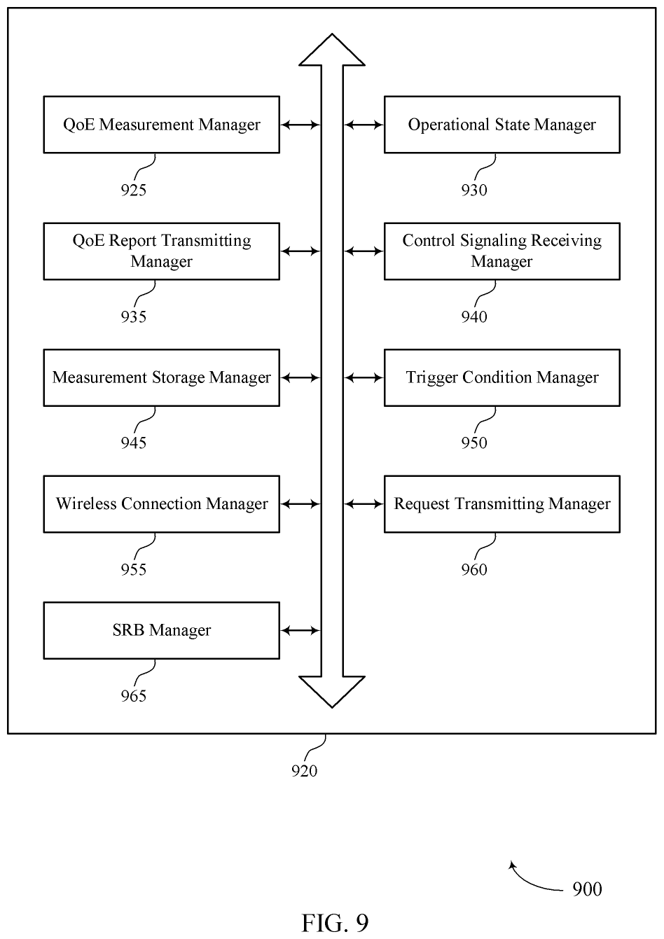

FIG. 9 shows a block diagram 900 of a communications manager 920 that supports techniques for QoE measurement and reporting in idle and inactive states in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for QoE measurement and reporting in idle and inactive states as described herein. For example, the communications manager 920 may include a QoE measurement manager 925, an operational state manager 930, a QoE report transmitting manager 935, a control signaling receiving manager 940, a measurement storage manager 945, a trigger condition manager 950, a wireless connection manager 955, a request transmitting manager 960, an SRB manager 965, or any combination thereof. Each of these components may communicate, directly or indirectly, with one another (e.g., via one or more buses).

The communications manager 920 may support wireless communication at a UE in accordance with examples as disclosed herein. The QoE measurement manager 925 may be configured as or otherwise support a means for performing, while operating in a connected state, a first set of QoE measurements in accordance with a first QoE measurement and reporting configuration associated with the connected state. The operational state manager 930 may be configured as or otherwise support a means for transitioning from the connected state to one of an idle state or an inactive state. In some examples, the QoE measurement manager 925 may be configured as or otherwise support a means for performing, while operating in the idle state or the inactive state, a second set of QoE measurements in accordance with a second QoE measurement and reporting configuration associated with the idle state, the inactive state, or both, the second QoE measurement and reporting configuration different from the first QoE measurement and reporting configuration. The QoE report transmitting manager 935 may be configured as or otherwise support a means for transmitting, to a network entity, a QoE report including at least the second set of QoE measurements.

In some examples, the control signaling receiving manager 940 may be configured as or otherwise support a means for receiving, from the network entity, a control message instructing the UE to transition from the connected state to the idle state or the inactive state, the control message modifying one or more parameters associated with the first QoE measurement and reporting configuration, where transitioning to the idle state or the inactive state is based on the control message, and where the second QoE measurement and reporting configuration includes a modified version of the first QoE measurement and reporting configuration based on the control message.

In some examples, the control message includes an RRC release message.

In some examples, the control signaling receiving manager 940 may be configured as or otherwise support a means for receiving, from the network entity, a control message indicating the first QoE measurement and reporting configuration and the second QoE measurement and reporting configuration, where performing the first set of QoE, measurements, performing the second set of QoE measurements, or both, is based on the control message.

In some examples, the control signaling receiving manager 940 may be configured as or otherwise support a means for receiving, from the network entity, a control message instructing the UE to transition from the connected state to the idle state or the inactive state, the control message indicating the second QoE measurement and reporting configuration, where transitioning to the idle state or the inactive state and performing the second set of QoE measurements is based on the control message.

In some examples, the measurement storage manager 945 may be configured as or otherwise support a means for storing the second set of QoE measurements in memory in accordance with the second QoE measurement and reporting configuration while operating in the idle state or the inactive state. In some examples, the operational state manager 930 may be configured as or otherwise support a means for transitioning from the idle state or the inactive state to the connected state, where transmitting the QoE report occurs after transitioning to the connected state and is based on storing the second set of QoE measurements in memory while operating in the idle state or the inactive state.

In some examples, the trigger condition manager 950 may be configured as or otherwise support a means for identifying a satisfaction of a trigger condition for QoE reporting while operating in the idle state or the inactive state. In some examples, the operational state manager 930 may be configured as or otherwise support a means for transitioning from the idle state or the inactive state to the connected state based on the satisfaction of the trigger condition, where transmitting the QoE report occurs after transitioning to the connected state.

In some examples, the control signaling receiving manager 940 may be configured as or otherwise support a means for receiving, from the network entity, a control message indicating a set of multiple trigger conditions for QoE reporting, the set of multiple trigger conditions including the trigger condition, where identifying the satisfaction of the trigger condition is based on the control message.

In some examples, the trigger condition manager 950 may be configured as or otherwise support a means for determining that at least one QoE measurement of the second set of QoE measurements is less than or equal to a QoE threshold, where identifying the satisfaction of the trigger condition is based on the at least one QoE measurement being less than or equal to the QoE threshold.

In some examples, the wireless connection manager 955 may be configured as or otherwise support a means for establishing a wireless connection with a second cell different than the first cell while operating in the idle state or the inactive state, where the QoE report is transmitted to at least the second cell based on establishing the wireless connection with the second cell, and where the QoE report includes a cell ID associated with the second cell.

In some examples, the request transmitting manager 960 may be configured as or otherwise support a means for transmitting, to the network entity while operating in the idle state or the inactive state, a request to establish or resume a wireless connection with the network entity. In some examples, the operational state manager 930 may be configured as or otherwise support a means for transitioning from the idle state or the inactive state to the connected state based on transmitting the request, where transmitting the QoE report occurs after transitioning to the connected state.

In some examples, the request transmitting manager 960 may be configured as or otherwise support a means for transmitting, to the network entity while operating in the idle state or the inactive state, a request to establish or resume a wireless connection with the network entity. In some examples, the SRB manager 965 may be configured as or otherwise support a means for receiving, from the network entity based on the request, an indication of a SRB for QoE reporting, where the QoE measurement and reporting configuration is transmitted via the indicated SRB.

In some examples, the SRB manager 965 may be configured as or otherwise support a means for receiving, from the network entity, an indication of a SRB associated with wireless communications between the UE and the network entity. In some examples, the QoE report transmitting manager 935 may be configured as or otherwise support a means for transmitting the QoE report while operating in the inactive state via the SRB based on maintaining the SRB as active while operating in the inactive state.

In some examples, the second QoE measurement and reporting configuration is associated with at least RAN-visible QoE information capable of being decoded by the network entity. In some examples, the second set of QoE measurements include at least one RAN-visible QoE measurement capable of being decoded by the network entity.

In some examples, the first QoE measurement and reporting configuration is associated with a first set of parameters. In some examples, the second QoE measurement and reporting configuration is associated with a second set of parameters different from the first set of parameters. In some examples, the first set of parameters, the second set of parameters, or both, include a measurement periodicity, a reporting periodicity, a measurement quantity, a measurement quality, or any combination thereof.

In some examples, the first QoE measurement and reporting configuration is associated with a first power consumption at the UE. In some examples, the second QoE measurement and reporting configuration is associated with a second power consumption at the UE that is less than the first power consumption.

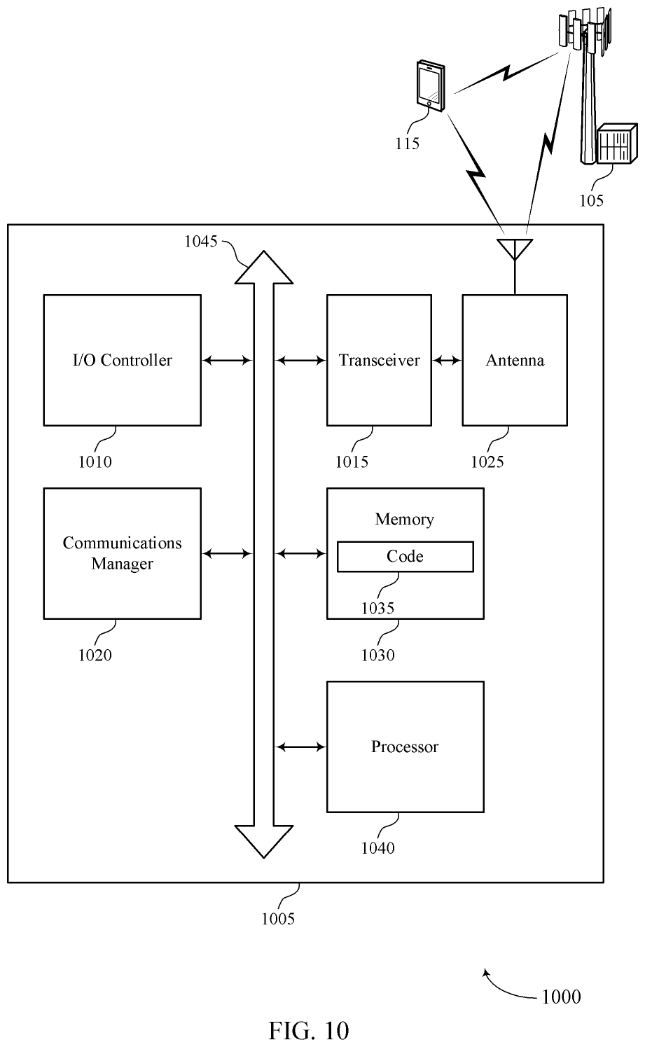

FIG. 10 shows a diagram of a system 1000 including a device 1005 that supports techniques for QoE measurement and reporting in idle and inactive states in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for QoE measurement and reporting in idle and inactive states). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for performing, while operating in a connected state, a first set of QoE measurements in accordance with a first QoE measurement and reporting configuration associated with the connected state. The communications manager 1020 may be configured as or otherwise support a means for transitioning from the connected state to one of an idle state or an inactive state. The communications manager 1020 may be configured as or otherwise support a means for performing, while operating in the idle state or the inactive state, a second set of QoE measurements in accordance with a second QoE measurement and reporting configuration associated with the idle state, the inactive state, or both, the second QoE measurement and reporting configuration different from the first QoE measurement and reporting configuration. The communications manager 1020 may be configured as or otherwise support a means for transmitting, to a network entity, a QE report including at least the second set of QoE measurements.

By including or configuring the communications manager 1020 in accordance with examples as described herein, the device 1005 may support techniques which enable UEs 115 to perform QoE measurements while operating in an idle state, an inactive state, or both. As such, techniques described herein may enable UEs 115 to inform the network as to a relative quality of wireless communications received at the UE 115 during the idle and inactive states, including a relative quality of emergency broadcast messages. As such, aspects of the present disclosure may enable the network to adjust parameters of wireless communications to improve a relative quality of such wireless communications received by the UE 115 during the idle and inactive states. In this regard, aspects of the present disclosure may facilitate improved coordination between the UE 115 and the network, and improve an efficiency and reliability of application services provisioned over wireless communications received by the UE 115 during inactive and idle states.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for QoE measurement and reporting in idle and inactive states as described herein, or the processor 1040 and the memory 1030 may be otherwise configured to perform or support such operations.

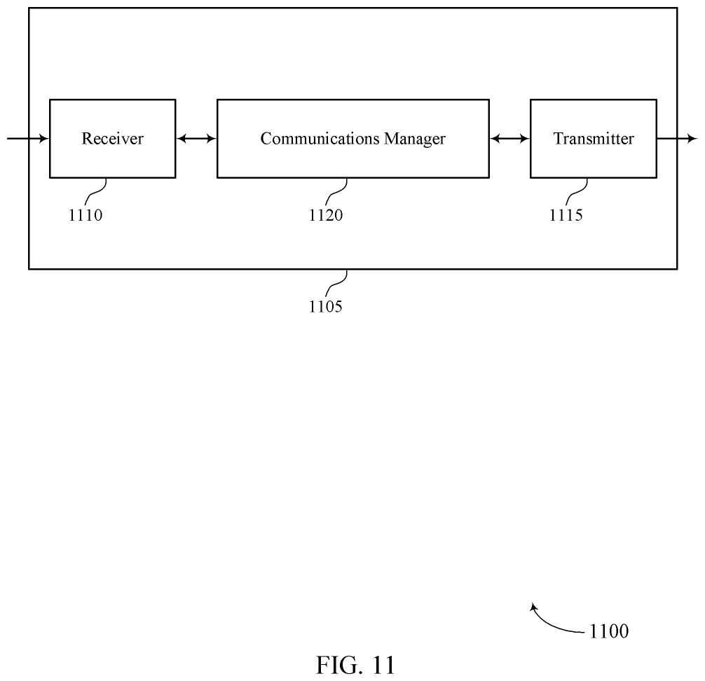

FIG. 11 shows a block diagram 1100 of a device 1105 that supports techniques for QoE measurement and reporting in idle and inactive states in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for QoE measurement and reporting in idle and inactive states as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for outputting, to a UE, a first control message indicating a first QoE measurement and reporting configuration for the UE to use to perform QoE measurements while in a connected state. The communications manager 1120 may be configured as or otherwise support a means for outputting, to the UE via the first control message or a second control message, a second QoE measurement and reporting configuration for the UE to use to perform QoE measurements while in an idle state, an inactive state, or both. The communications manager 1120 may be configured as or otherwise support a means for obtaining, from the UE, a QoE report including a set of QoE measurements performed while the UE was operating in the idle state or the inactive state and in accordance with the second QoE measurement and reporting configuration.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques which enable UEs 115 to perform QoE measurements while operating in an idle state, an inactive state, or both. As such, techniques described herein may enable UEs 115 to inform the network as to a relative quality of wireless communications received at the UE 115 during the idle and inactive states, including a relative quality of emergency broadcast messages. As such, aspects of the present disclosure may enable the network to adjust parameters of wireless communications to improve a relative quality of such wireless communications received by the UE 115 during the idle and inactive states. In this regard, aspects of the present disclosure may facilitate improved coordination between the UE 115 and the network, and improve an efficiency and reliability of application services provisioned over wireless communications received by the UE 115 during inactive and idle states.

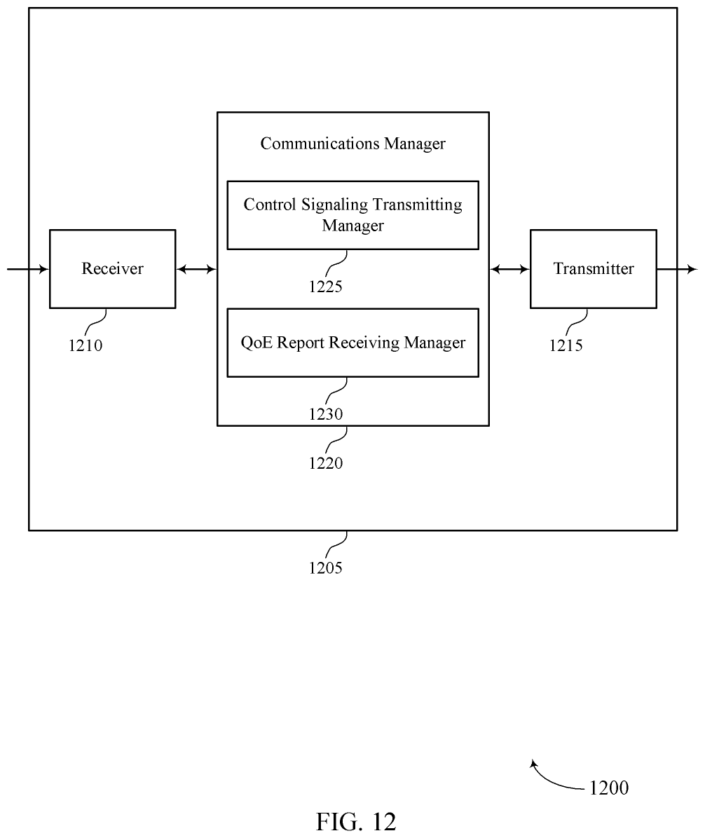

FIG. 12 shows a block diagram 1200 of a device 1205 that supports techniques for QoE measurement and reporting in idle and inactive states in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for QoE measurement and reporting in idle and inactive states as described herein. For example, the communications manager 1220 may include a control signaling transmitting manager 1225 a QoE report receiving manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The control signaling transmitting manager 1225 may be configured as or otherwise support a means for outputting, to a UE, a first control message indicating a first QoE measurement and reporting configuration for the UE to use to perform QoE measurements while in a connected state. The control signaling transmitting manager 1225 may be configured as or otherwise support a means for outputting, to the UE via the first control message or a second control message, a second QoE measurement and reporting configuration for the UE to use to perform QoE measurements while in an idle state, an inactive state, or both. The QoE report receiving manager 1230 may be configured as or otherwise support a means for obtaining, from the UE, a QoE report including a set of QoE measurements performed while the UE was operating in the idle state or the inactive state and in accordance with the second QoE measurement and reporting configuration.

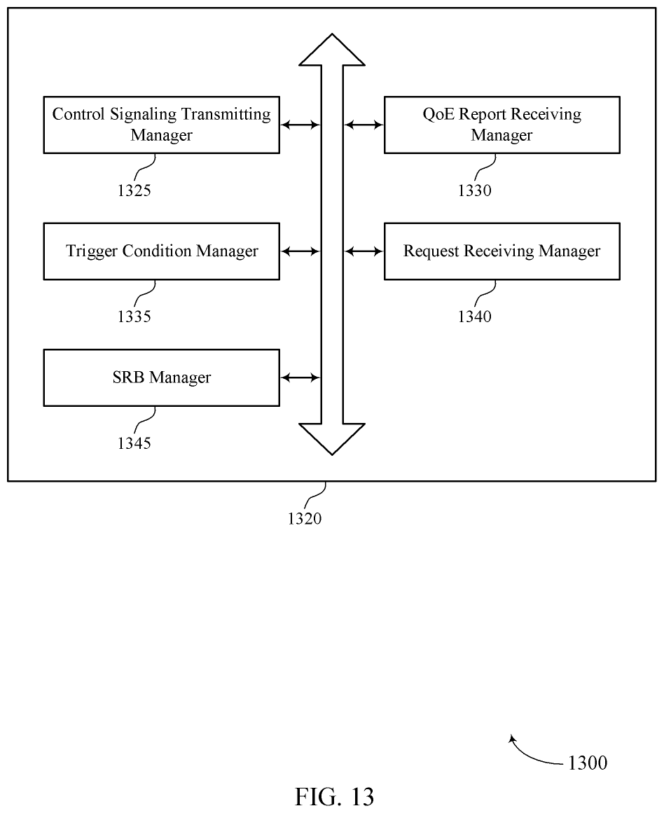

FIG. 13 shows a block diagram 1300 of a communications manager 1320 that supports techniques for QoE measurement and reporting in idle and inactive states in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for QoE measurement and reporting in idle and inactive states as described herein. For example, the communications manager 1320 may include a control signaling transmitting manager 1325, a QoE report receiving manager 1330, a trigger condition manager 1335, a request receiving manager 1340, an SRB manager 1345, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The control signaling transmitting manager 1325 may be configured as or otherwise support a means for outputting, to a UE, a first control message indicating a first QoE measurement and reporting configuration for the UE to use to perform QoE measurements while in a connected state. In some examples, the control signaling transmitting manager 1325 may be configured as or otherwise support a means for outputting, to the UE via the first control message or a second control message, a second QoE measurement and reporting configuration for the UE to use to perform QoE measurements while in an idle state, an inactive state, or both. The QoE report receiving manager 1330 may be configured as or otherwise support a means for obtaining, from the UE, a QoE report including a set of QoE measurements performed while the UE was operating in the idle state or the inactive state and in accordance with the second QoE measurement and reporting configuration.

In some examples, the second control message instructs the UE to transition from the connected state to the idle state or the inactive state and modifies one or more parameters associated with the first QoE measurement and reporting configuration. In some examples, the second QoE measurement and reporting configuration includes a modified version of the first QoE measurement and reporting configuration based on the second control message. In some examples, the second control message includes an RRC release message.

In some examples, the second control message instructs the UE to transition from the connected state to the idle state or the inactive state and indicates the second QoE measurement and reporting configuration. In some examples, obtaining the QoE report is based on the second control message.

In some examples, the trigger condition manager 1335 may be configured as or otherwise support a means for indicating, to the UE via the first control message, the second control message, an additional control message, or any combination thereof, a set of multiple trigger conditions for QoE reporting, where receiving the QoE report is based on a satisfaction of a trigger condition from the set of multiple trigger conditions.

In some examples, the request receiving manager 1340 may be configured as or otherwise support a means for obtaining, from the UE, a request to establish or resume a wireless connection with the network entity, where obtaining the QoE report occurs after the wireless connection is established or resumed.

In some examples, the request receiving manager 1340 may be configured as or otherwise support a means for obtaining, from the UE, a request to establish or resume a wireless connection with the network entity. In some examples, the SRB manager 1345 may be configured as or otherwise support a means for outputting, to the UE based on the request, an indication of a SRB for QoE reporting, where the QoE measurement and reporting configuration is obtained via the indicated SRB.

In some examples, the SRB manager 1345 may be configured as or otherwise support a means for outputting, to the UE, an indication of a SRB associated with wireless communications between the UE and the network entity. In some examples, the QoE report receiving manager 1330 may be configured as or otherwise support a means for obtaining the QoE report from the UE via the SRB based on the SRB being maintained as active while the UE is in the inactive state.

In some examples, the second QoE measurement and reporting configuration is associated with at least RAN-visible QoE information capable of being decoded by the network entity. In some examples, the set of QoE measurements include at least one RAN-visible QoE measurement capable of being decoded by the network entity.

In some examples, the first QoE measurement and reporting configuration is associated with a first set of parameters. In some examples, the second QoE measurement and reporting configuration is associated with a second set of parameters different from the first set of parameters. In some examples, the first set of parameters, the second set of parameters, or both, include a measurement periodicity, a reporting periodicity, a measurement quantity, a measurement quality, or any combination thereof.

In some examples, the first QoE measurement and reporting configuration is associated with a first power consumption at the UE. In some examples, the second QoE measurement and reporting configuration is associated with a second power consumption at the UE that is less than the first power consumption.

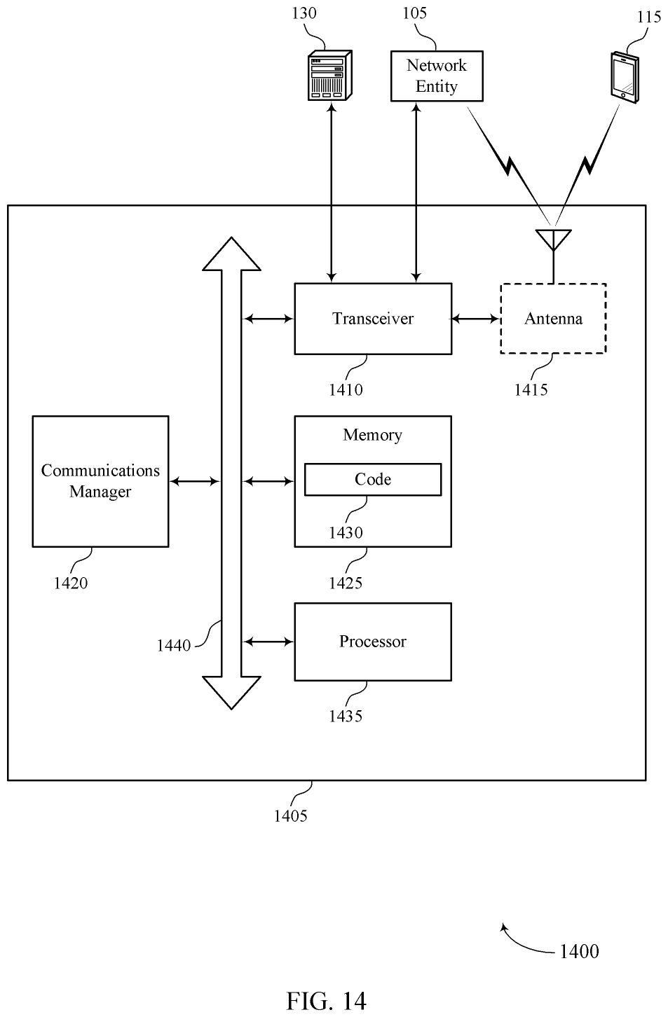

FIG. 14 shows a diagram of a system 1400 including a device 1405 that supports techniques for QoE measurement and reporting in idle and inactive states in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting techniques for QoE measurement and reporting in idle and inactive states). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for outputting, to a UE, a first control message indicating a first QoE measurement and reporting configuration for the UE to use to perform QoE measurements while in a connected state. The communications manager 1420 may be configured as or otherwise support a means for outputting, to the UE via the first control message or a second control message, a second QoE measurement and reporting configuration for the UE to use to perform QoE measurements while in an idle state, an inactive state, or both. The communications manager 1420 may be configured as or otherwise support a means for obtaining, from the UE, a QoE report including a set of QoE measurements performed while the UE was operating in the idle state or the inactive state and in accordance with the second QoE measurement and reporting configuration.

By including or configuring the communications manager 1420 in accordance with examples as described herein, the device 1405 may support techniques which enable UEs 115 to perform QoE measurements while operating in an idle state, an inactive state, or both. As such, techniques described herein may enable UEs 115 to inform the network as to a relative quality of wireless communications received at the UE 115 during the idle and inactive states, including a relative quality of emergency broadcast messages. As such, aspects of the present disclosure may enable the network to adjust parameters of wireless communications to improve a relative quality of such wireless communications received by the UE 115 during the idle and inactive states. In this regard, aspects of the present disclosure may facilitate improved coordination between the UE 115 and the network, and improve an efficiency and reliability of application services provisioned over wireless communications received by the UE 115 during inactive and idle states.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of techniques for QoE measurement and reporting in idle and inactive states as described herein, or the processor 1435 and the memory 1425 may be otherwise configured to perform or support such operations.

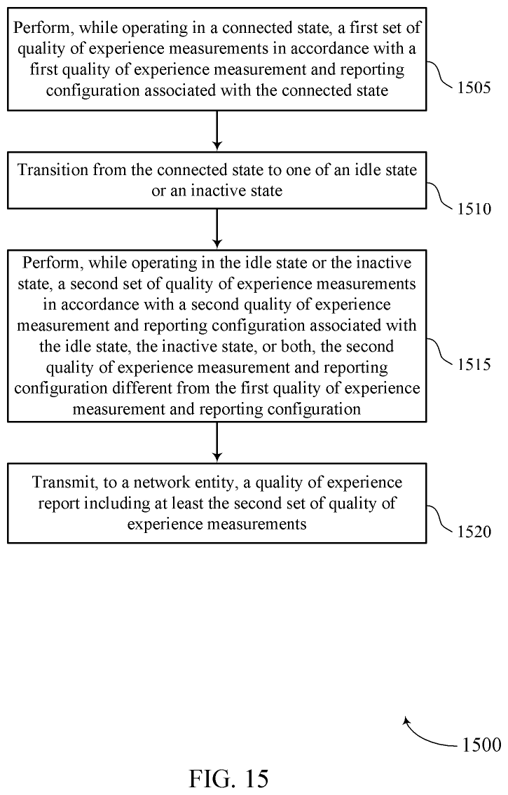

FIG. 15 shows a flowchart illustrating a method 1500 that supports techniques for QoE measurement and reporting in idle and inactive states in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include performing, while operating in a connected state, a first set of QoE measurements in accordance with a first QoE measurement and reporting configuration associated with the connected state. The operations of 1505 may be performed in accordance with examples as disclosed herein. In some examples, aspects of the operations of 1505 may be performed by a QoE measurement manager 925 as described with reference to FIG. 9.

At 1510, the method may include transitioning from the connected state to one of an idle state or an inactive state. The operations of 1510 may be performed in accordance with examples as disclosed herein. In some examples, aspects of the operations of 1510 may be performed by an operational state manager 930 as described with reference to FIG. 9.

At 1515, the method may include performing, while operating in the idle state or the inactive state, a second set of QoE measurements in accordance with a second QoE measurement and reporting configuration associated with the idle state, the inactive state, or both, the second QoE measurement and reporting configuration different from the first QoE measurement and reporting configuration. The operations of 1515 may be performed in accordance with examples as disclosed herein. In some examples, aspects of the operations of 1515 may be performed by a QoE measurement manager 925 as described with reference to FIG. 9.

At 1520, the method may include transmitting, to a network entity, a QoE report including at least the second set of QoE measurements. The operations of 1520 may be performed in accordance with examples as disclosed herein. In some examples, aspects of the operations of 1520 may be performed by a QoE report transmitting manager 935 as described with reference to FIG. 9.

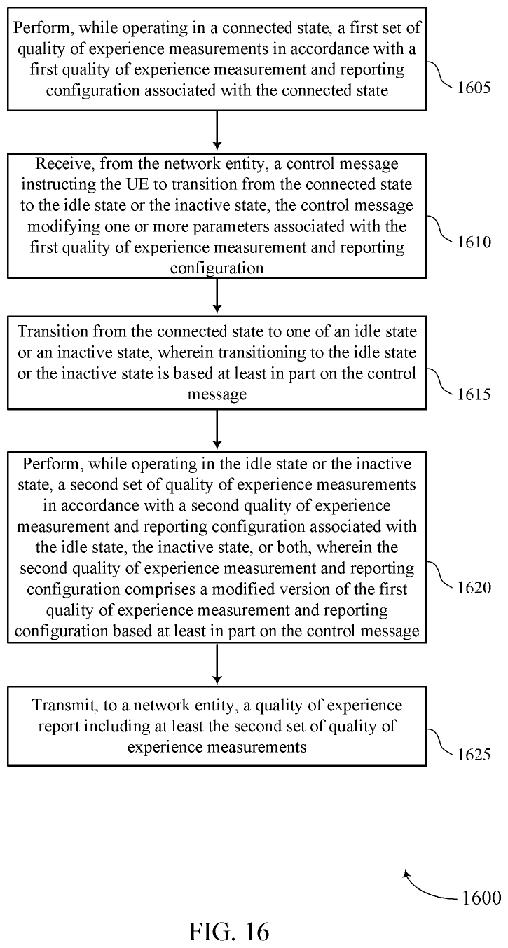

FIG. 16 shows a flowchart illustrating a method 1600 that supports techniques for QoE measurement and reporting in idle and inactive states in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include performing, while operating in a connected state, a first set of QoE measurements in accordance with a first QoE measurement and reporting configuration associated with the connected state. The operations of 1605 may be performed in accordance with examples as disclosed herein. In some examples, aspects of the operations of 1605 may be performed by a QoE measurement manager 925 as described with reference to FIG. 9.

At 1610, the method may include receiving, from the network entity, a control message instructing the UE to transition from the connected state to the idle state or the inactive state, the control message modifying one or more parameters associated with the first QoE measurement and reporting configuration. The operations of 1610 may be performed in accordance with examples as disclosed herein. In some examples, aspects of the operations of 1610 may be performed by a control signaling receiving manager 940 as described with reference to FIG. 9.

At 1615, the method may include transitioning from the connected state to one of an idle state or an inactive state, where transitioning to the idle state or the inactive state is based on the control message. The operations of 1615 may be performed in accordance with examples as disclosed herein. In some examples, aspects of the operations of 1615 may be performed by an operational state manager 930 as described with reference to FIG. 9.

At 1620, the method may include performing, while operating in the idle state or the inactive state, a second set of QoE measurements in accordance with a second QoE measurement and reporting configuration associated with the idle state, the inactive state, or both, and where the second QoE measurement and reporting configuration includes a modified version of the first QoE measurement and reporting configuration based on the control message. The operations of 1620 may be performed in accordance with examples as disclosed herein. In some examples, aspects of the operations of 1620 may be performed by a QoE measurement manager 925 as described with reference to FIG. 9.

At 1625, the method may include transmitting, to a network entity, a QoE report including at least the second set of QoE measurements. The operations of 1625 may be performed in accordance with examples as disclosed herein. In some examples, aspects of the operations of 1625 may be performed by a QoE report transmitting manager 935 as described with reference to FIG. 9.

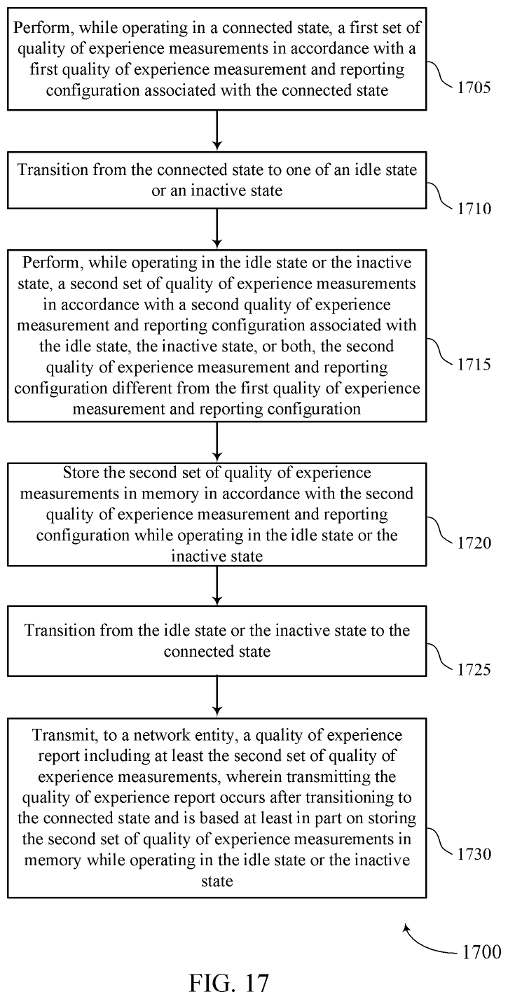

FIG. 17 shows a flowchart illustrating a method 1700 that supports techniques for QoE measurement and reporting in idle and inactive states in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include performing, while operating in a connected state, a first set of QoE measurements in accordance with a first QoE measurement and reporting configuration associated with the connected state. The operations of 1705 may be performed in accordance with examples as disclosed herein. In some examples, aspects of the operations of 1705 may be performed by a QoE measurement manager 925 as described with reference to FIG. 9.

At 1710, the method may include transitioning from the connected state to one of an idle state or an inactive state. The operations of 1710 may be performed in accordance with examples as disclosed herein. In some examples, aspects of the operations of 1710 may be performed by an operational state manager 930 as described with reference to FIG. 9.

At 1715, the method may include performing, while operating in the idle state or the inactive state, a second set of QoE measurements in accordance with a second QoE measurement and reporting configuration associated with the idle state, the inactive state, or both, the second QoE measurement and reporting configuration different from the first QoE measurement and reporting configuration. The operations of 1715 may be performed in accordance with examples as disclosed herein. In some examples, aspects of the operations of 1715 may be performed by a QoE measurement manager 925 as described with reference to FIG. 9.

At 1720, the method may include storing the second set of QoE measurements in memory in accordance with the second QoE measurement and reporting configuration while operating in the idle state or the inactive state. The operations of 1720 may be performed in accordance with examples as disclosed herein. In some examples, aspects of the operations of 1720 may be performed by a measurement storage manager 945 as described with reference to FIG. 9.

At 1725, the method may include transitioning from the idle state or the inactive state to the connected state. The operations of 1725 may be performed in accordance with examples as disclosed herein. In some examples, aspects of the operations of 1725 may be performed by an operational state manager 930 as described with reference to FIG. 9.

At 1730, the method may include transmitting, to a network entity, a QoE report including at least the second set of QoE measurements, where transmitting the QoE report occurs after transitioning to the connected state and is based on storing the second set of QoE measurements in memory while operating in the idle state or the inactive state. The operations of 1730 may be performed in accordance with examples as disclosed herein. In some examples, aspects of the operations of 1730 may be performed by a QoE report transmitting manager 935 as described with reference to FIG. 9.

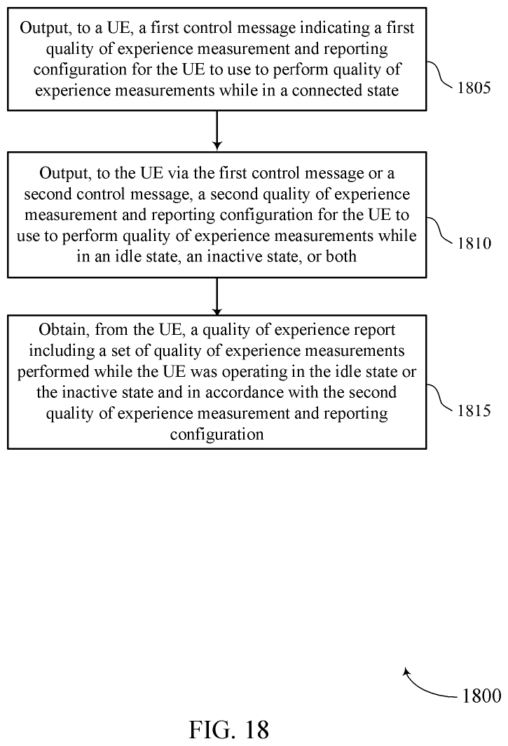

FIG. 18 shows a flowchart illustrating a method 1800 that supports techniques for QoE measurement and reporting in idle and inactive states in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting, to a UE, a first control message indicating a first QoE measurement and reporting configuration for the UE to use to perform QoE measurements while in a connected state. The operations of 1805 may be performed in accordance with examples as disclosed herein. In some examples, aspects of the operations of 1805 may be performed by a control signaling transmitting manager 1325 as described with reference to FIG. 13.

At 1810, the method may include outputting, to the UE via the first control message or a second control message, a second QoE measurement and reporting configuration for the UE to use to perform QoE measurements while in an idle state, an inactive state, or both. The operations of 1810 may be performed in accordance with examples as disclosed herein. In some examples, aspects of the operations of 1810 may be performed by a control signaling transmitting manager 1325 as described with reference to FIG. 13.

At 1815, the method may include obtaining, from the UE, a QoE report including a set of QoE measurements performed while the UE was operating in the idle state or the inactive state and in accordance with the second QoE measurement and reporting configuration. The operations of 1815 may be performed in accordance with examples as disclosed herein. In some examples, aspects of the operations of 1815 may be performed by a QoE report receiving manager 1330 as described with reference to FIG. 13.

The following provides an overview of aspects of the present disclosure:

Aspect 1: A method for wireless communication at a UE, comprising: performing, while operating in a connected state, a first set of QoE measurements in accordance with a first QoE measurement and reporting configuration associated with the connected state: transitioning from the connected state to one of an idle state or an inactive state: performing, while operating in the idle state or the inactive state, a second set of QoE measurements in accordance with a second QoE measurement and reporting configuration associated with the idle state, the inactive state, or both, the second QoE measurement and reporting configuration different from the first QoE measurement and reporting configuration; and transmitting, to a network entity, a QoE report including at least the second set of QoE measurements.

Aspect 2: The method of aspect 1, further comprising: receiving, from the network entity, a control message instructing the UE to transition from the connected state to the idle state or the inactive state, the control message modifying one or more parameters associated with the first QoE measurement and reporting configuration, wherein transitioning to the idle state or the inactive state is based at least in part on the control message, and wherein the second QoE measurement and reporting configuration comprises a modified version of the first QoE measurement and reporting configuration based at least in part on the control message.

Aspect 3: The method of aspect 2, wherein the control message comprises an RRC release message.

Aspect 4: The method of any of aspects 1 through 3, further comprising: receiving, from the network entity, a control message indicating the first QoE measurement and reporting configuration and the second QoE measurement and reporting configuration, wherein performing the first set of QoE, measurements, performing the second set of QoE measurements, or both, is based at least in part on the control message.

Aspect 5: The method of any of aspects 1 through 4, further comprising: receiving, from the network entity, a control message instructing the UE to transition from the connected state to the idle state or the inactive state, the control message indicating the second QoE measurement and reporting configuration, wherein transitioning to the idle state or the inactive state and performing the second set of QoE measurements is based at least in part on the control message.

Aspect 6: The method of any of aspects 1 through 5, further comprising: storing the second set of QoE measurements in memory in accordance with the second QoE measurement and reporting configuration while operating in the idle state or the inactive state; and transitioning from the idle state or the inactive state to the connected state, wherein transmitting the QoE report occurs after transitioning to the connected state and is based at least in part on storing the second set of QoE measurements in memory while operating in the idle state or the inactive state.

Aspect 7: The method of any of aspects 1 through 6, further comprising: identifying a satisfaction of a trigger condition for QoE reporting while operating in the idle state or the inactive state; and transitioning from the idle state or the inactive state to the connected state based at least in part on the satisfaction of the trigger condition, wherein transmitting the QoE report occurs after transitioning to the connected state.

Aspect 8: The method of aspect 7, further comprising: receiving, from the network entity, a control message indicating a plurality of trigger conditions for QoE reporting, the plurality of trigger conditions including the trigger condition, wherein identifying the satisfaction of the trigger condition is based at least in part on the control message.

Aspect 9: The method of any of aspects 7 through 8, further comprising: determining that at least one QoE measurement of the second set of QoE measurements is less than or equal to a QoE threshold, wherein identifying the satisfaction of the trigger condition is based at least in part on the at least one QoE measurement being less than or equal to the QoE threshold.

Aspect 10: The method of any of aspects 1 through 9, wherein operating in the connected state comprises communicating with a first cell, further comprising: establishing a wireless connection with a second cell different than the first cell while operating in the idle state or the inactive state, wherein the QoE report is transmitted to at least the second cell based at least in part on establishing the wireless connection with the second cell, and wherein the QoE report includes a cell identifier associated with the second cell.

Aspect 11: The method of any of aspects 1 through 10, further comprising: transmitting, to the network entity while operating in the idle state or the inactive state, a request to establish or resume a wireless connection with the network entity; and transitioning from the idle state or the inactive state to the connected state based at least in part on transmitting the request, wherein transmitting the QoE report occurs after transitioning to the connected state.

Aspect 12: The method of any of aspects 1 through 11, further comprising: transmitting, to the network entity while operating in the idle state or the inactive state, a request to establish or resume a wireless connection with the network entity; and receiving, from the network entity based at least in part on the request, an indication of a signaling radio bearer for QoE reporting, wherein the QoE measurement and reporting configuration is transmitted via the indicated signaling radio bearer.

Aspect 13: The method of any of aspects 1 through 12, further comprising: receiving, from the network entity, an indication of a signaling radio bearer associated with wireless communications between the UE and the network entity; and transmitting the QoE report while operating in the inactive state via the signaling radio bearer based at least in part on maintaining the signaling radio bearer as active while operating in the inactive state.

Aspect 14: The method of any of aspects 1 through 13, wherein the second QoE measurement and reporting configuration is associated with at least radio access network-aware QoE information capable of being decoded by the network entity, and the second set of QoE measurements comprise at least one radio access network-visible QoE measurement capable of being decoded by the network entity.

Aspect 15: The method of any of aspects 1 through 14, wherein the first QoE measurement and reporting configuration is associated with a first set of parameters, and the second QoE measurement and reporting configuration is associated with a second set of parameters different from the first set of parameters, the first set of parameters, the second set of parameters, or both, comprise a measurement periodicity, a reporting periodicity, a measurement quantity, a measurement quality, or any combination thereof.

Aspect 16: The method of any of aspects 1 through 15, wherein the first QoE measurement and reporting configuration is associated with a first power consumption at the UE, and the second QoE measurement and reporting configuration is associated with a second power consumption at the UE that is less than the first power consumption.

Aspect 17: A method for wireless communication at a network entity, comprising: outputting, to a UE, a first control message indicating a first QoE measurement and reporting configuration for the UE to use to perform QoE measurements while in a connected state: outputting, to the UE via the first control message or a second control message, a second QoE measurement and reporting configuration for the UE to use to perform QoE measurements while in an idle state, an inactive state, or both; and obtaining, from the UE, a QoE report including a set of QoE measurements performed while the UE was operating in the idle state or the inactive state and in accordance with the second QoE measurement and reporting configuration.

Aspect 18: The method of aspect 17, wherein the second control message instructs the UE to transition from the connected state to the idle state or the inactive state and modifies one or more parameters associated with the first QoE measurement and reporting configuration, and the second QoE measurement and reporting configuration comprises a modified version of the first QoE measurement and reporting configuration based at least in part on the second control message.

Aspect 19: The method of aspect 18, wherein the second control message comprises an RRC release message.

Aspect 20: The method of any of aspects 17 through 19, wherein the second control message instructs the UE to transition from the connected state to the idle state or the inactive state and indicates the second QoE measurement and reporting configuration, obtaining the QoE report is based at least in part on the second control message.

Aspect 21: The method of any of aspects 17 through 20, further comprising: indicating, to the UE via the first control message, the second control message, an additional control message, or any combination thereof, a plurality of trigger conditions for QoE reporting, wherein receiving the QoE report is based at least in part on a satisfaction of a trigger condition from the plurality of trigger conditions.

Aspect 22: The method of any of aspects 17 through 21, further comprising: obtaining, from the UE, a request to establish or resume a wireless connection with the network entity, wherein obtaining the QoE report occurs after the wireless connection is established or resumed.

Aspect 23: The method of any of aspects 17 through 22, further comprising: obtaining, from the UE, a request to establish or resume a wireless connection with the network entity; and outputting, to the UE based at least in part on the request, an indication of a signaling radio bearer for QoE reporting, wherein the QoE measurement and reporting configuration is obtained via the indicated signaling radio bearer.

Aspect 24: The method of any of aspects 17 through 23, further comprising: outputting, to the UE, an indication of a signaling radio bearer associated with wireless communications between the UE and the network entity; and obtaining the QoE report from the UE via the signaling radio bearer based at least in part on the signaling radio bearer being maintained as active while the UE is in the inactive state.

Aspect 25: The method of any of aspects 17 through 24, wherein the second QoE measurement and reporting configuration is associated with at least radio access network-aware QoE information capable of being decoded by the network entity, and the set of QoE measurements comprise at least one radio access network-visible QoE measurement capable of being decoded by the network entity.

Aspect 26: The method of any of aspects 17 through 25, wherein the first QoE measurement and reporting configuration is associated with a first set of parameters, and the second QoE measurement and reporting configuration is associated with a second set of parameters different from the first set of parameters, the first set of parameters, the second set of parameters, or both, comprise a measurement periodicity, a reporting periodicity, a measurement quantity, a measurement quality, or any combination thereof.

Aspect 27: The method of any of aspects 17 through 26, wherein the first QoE measurement and reporting configuration is associated with a first power consumption at the UE, and the second QoE measurement and reporting configuration is associated with a second power consumption at the UE that is less than the first power consumption.

Aspect 28: An apparatus for wireless communication at a UE, comprising a processor: memory coupled with the processor; and instructions stored in the memory and executable by the processor to cause the apparatus to perform a method of any of aspects 1 through 16.

Aspect 29: An apparatus for wireless communication at a UE, comprising at least one means for performing a method of any of aspects 1 through 16.

Aspect 30: A non-transitory computer-readable medium storing code for wireless communication at a UE, the code comprising instructions executable by a processor to perform a method of any of aspects 1 through 16.

Aspect 31: An apparatus for wireless communication at a network entity, comprising a processor: memory coupled with the processor; and instructions stored in the memory and executable by the processor to cause the apparatus to perform a method of any of aspects 17 through 27.

Aspect 32: An apparatus for wireless communication at a network entity, comprising at least one means for performing a method of any of aspects 17 through 27.

Aspect 33: A non-transitory computer-readable medium storing code for wireless communication at a network entity, the code comprising instructions executable by a processor to perform a method of any of aspects 17 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
perform, while operating in a connected state, a first set of quality of experience measurements in accordance with a first quality of experience measurement and reporting configuration associated with the connected state;
transition from the connected state to one of an idle state or an inactive state;
perform, while operating in the idle state or the inactive state, a second set of quality of experience measurements in accordance with a second quality of experience measurement and reporting configuration associated with the idle state, the inactive state, or both, the second quality of experience measurement and reporting configuration different from the first quality of experience measurement and reporting configuration; and
transmit, to a network entity, a quality of experience report including at least the second set of quality of experience measurements.

2. The apparatus of claim 1, wherein the instructions are further executable by the processor to cause the apparatus to:
receive, from the network entity, a control message instructing the UE to transition from the connected state to the idle state or the inactive state, the control message modifying one or more parameters associated with the first quality of experience measurement and reporting configuration, wherein transitioning to the idle state or the inactive state is based at least in part on the control message, and wherein the second quality of experience measurement and reporting configuration comprises a modified version of the first quality of experience measurement and reporting configuration based at least in part on the control message.

3. The apparatus of claim 2, wherein the control message comprises a radio resource control release message.

4. The apparatus of claim 1, wherein the instructions are further executable by the processor to cause the apparatus to:
receive, from the network entity, a control message indicating the first quality of experience measurement and reporting configuration and the second quality of experience measurement and reporting configuration, wherein performing the first set of quality of experience measurements, performing the second set of quality of experience measurements, or both, is based at least in part on the control message.

5. The apparatus of claim 1, wherein the instructions are further executable by the processor to cause the apparatus to:
receive, from the network entity, a control message instructing the UE to transition from the connected state to the idle state or the inactive state, the control message indicating the second quality of experience measurement and reporting configuration, wherein transitioning to the idle state or the inactive state and performing the second set of quality of experience measurements are based at least in part on the control message.

6. The apparatus of claim 1, wherein the instructions are further executable by the processor to cause the apparatus to:
store the second set of quality of experience measurements in memory in accordance with the second quality of experience measurement and reporting configuration while operating in the idle state or the inactive state; and
transition from the idle state or the inactive state to the connected state, wherein transmitting the quality of experience report occurs after transitioning to the connected state and is based at least in part on storing the second set of quality of experience measurements in memory while operating in the idle state or the inactive state.

7. The apparatus of claim 1, wherein the instructions are further executable by the processor to cause the apparatus to:
identify a satisfaction of a trigger condition for quality of experience reporting while operating in the idle state or the inactive state; and
transition from the idle state or the inactive state to the connected state based at least in part on the satisfaction of the trigger condition, wherein transmitting the quality of experience report occurs after transitioning to the connected state.

8. The apparatus of claim 7, wherein the instructions are further executable by the processor to cause the apparatus to:
receive, from the network entity, a control message indicating a plurality of trigger conditions for quality of experience reporting, the plurality of trigger conditions including the trigger condition, wherein identifying the satisfaction of the trigger condition is based at least in part on the control message.

9. The apparatus of claim 7, wherein the instructions are further executable by the processor to cause the apparatus to:
determine that at least one quality of experience measurement of the second set of quality of experience measurements is less than or equal to a quality of experience threshold, wherein identifying the satisfaction of the trigger condition is based at least in part on the at least one quality of experience measurement being less than or equal to the quality of experience threshold.

10. The apparatus of claim 1, wherein operating in the connected state comprises communicating with a first cell, wherein the instructions are further executable by the processor to cause the apparatus to:
establish a wireless connection with a second cell different than the first cell while operating in the idle state or the inactive state, wherein the quality of experience report is transmitted to at least the second cell based at least in part on establishing the wireless connection with the second cell, and wherein the quality of experience report includes a cell identifier associated with the second cell.

11. The apparatus of claim 1, wherein the instructions are further executable by the processor to cause the apparatus to:
transmit, to the network entity while operating in the idle state or the inactive state, a request to establish or resume a wireless connection with the network entity; and
transition from the idle state or the inactive state to the connected state based at least in part on transmitting the request, wherein transmitting the quality of experience report occurs after transitioning to the connected state.

12. The apparatus of claim 1, wherein the instructions are further executable by the processor to cause the apparatus to:
transmit, to the network entity while operating in the idle state or the inactive state, a request to establish or resume a wireless connection with the network entity; and
receive, from the network entity based at least in part on the request, an indication of a signaling radio bearer for quality of experience reporting, wherein the quality of experience report is transmitted via the indicated signaling radio bearer.

13. The apparatus of claim 1, wherein the instructions are further executable by the processor to cause the apparatus to:
receive, from the network entity, an indication of a signaling radio bearer associated with wireless communications between the UE and the network entity; and
transmit the quality of experience report while operating in the inactive state via the signaling radio bearer based at least in part on maintaining the signaling radio bearer as active while operating in the inactive state.

14. The apparatus of claim 1, wherein the second quality of experience measurement and reporting configuration is associated with at least radio access network-visible quality of experience information capable of being decoded by the network entity, and wherein the second set of quality of experience measurements comprise at least one radio access network-visible quality of experience measurement capable of being decoded by the network entity.

15. The apparatus of claim 1, wherein the first quality of experience measurement and reporting configuration is associated with a first set of parameters, and the second quality of experience measurement and reporting configuration is associated with a second set of parameters different from the first set of parameters, wherein the first set of parameters, the second set of parameters, or both, comprise a measurement periodicity, a reporting periodicity, a measurement quantity, a measurement quality, or any combination thereof.

16. The apparatus of claim 1, wherein the first quality of experience measurement and reporting configuration is associated with a first power consumption at the UE, and the second quality of experience measurement and reporting configuration is associated with a second power consumption at the UE that is less than the first power consumption.

17. An apparatus for wireless communication at a network entity, comprising:
a processor;
memory coupled with the processor; and
instructions stored in the memory and executable by the processor to cause the apparatus to:
output, to a user equipment (UE), a first control message indicating a first quality of experience measurement and reporting configuration for the UE to use to perform quality of experience measurements while in a connected state;
output, to the UE via the first control message or a second control message, a second quality of experience measurement and reporting configuration for the UE to use to perform quality of experience measurements while in an idle state, an inactive state, or both; and
obtain, from the UE, a quality of experience report including a set of quality of experience measurements performed while the UE was operating in the idle state or the inactive state and in accordance with the second quality of experience measurement and reporting configuration.

18. The apparatus of claim 17, wherein the second control message instructs the UE to transition from the connected state to the idle state or the inactive state and modifies one or more parameters associated with the first quality of experience measurement and reporting configuration, and wherein the second quality of experience reporting measurement and configuration comprises a modified version of the first quality of experience measurement and reporting configuration based at least in part on the second control message.

19. The apparatus of claim 18, wherein the second control message comprises a radio resource control release message.

20. The apparatus of claim 17, wherein the second control message instructs the UE to transition from the connected state to the idle state or the inactive state and indicates the second quality of experience measurement and reporting configuration, and wherein obtaining the quality of experience report is based at least in part on the second control message.

21. The apparatus of claim 17, wherein the instructions are further executable by the processor to cause the apparatus to:
indicate, to the UE via the first control message, the second control message, an additional control message, or any combination thereof, a plurality of trigger conditions for quality of experience reporting, wherein obtaining the quality of experience report is based at least in part on a satisfaction of a trigger condition from the plurality of trigger conditions.

22. The apparatus of claim 17, wherein the instructions are further executable by the processor to cause the apparatus to:
obtain, from the UE, a request to establish or resume a wireless connection with the network entity, wherein obtaining the quality of experience report occurs after the wireless connection is established or resumed.

23. The apparatus of claim 17, wherein the instructions are further executable by the processor to cause the apparatus to:
obtain, from the UE, a request to establish or resume a wireless connection with the network entity; and
output, to the UE based at least in part on the request, an indication of a signaling radio bearer for quality of experience reporting, wherein the quality of experience report is obtained via the indicated signaling radio bearer.

24. The apparatus of claim 17, wherein the instructions are further executable by the processor to cause the apparatus to:
output, to the UE, an indication of a signaling radio bearer associated with wireless communications between the UE and the network entity; and
obtain the quality of experience report from the UE via the signaling radio bearer based at least in part on the signaling radio bearer being maintained as active while the UE is in the inactive state.

25. The apparatus of claim 17, wherein the second quality of experience measurement and reporting configuration is associated with at least radio access network-visible quality of experience information capable of being decoded by the network entity, and wherein the set of quality of experience measurements comprise at least one radio access network-visible quality of experience measurement capable of being decoded by the network entity.

26. The apparatus of claim 17, wherein the first quality of experience measurement and reporting configuration is associated with a first set of parameters, and the second quality of experience measurement and reporting configuration is associated with a second set of parameters different from the first set of parameters, wherein the first set of parameters, the second set of parameters, or both, comprise a measurement periodicity, a reporting periodicity, a measurement quantity, a measurement quality, or any combination thereof.

27. The apparatus of claim 17, wherein the first quality of experience measurement and reporting configuration is associated with a first power consumption at the UE, and the second quality of experience measurement and reporting configuration is associated with a second power consumption at the UE that is less than the first power consumption.

28. A method for wireless communication at a user equipment (UE), comprising:
performing, while operating in a connected state, a first set of quality of experience measurements in accordance with a first quality of experience measurement and reporting configuration associated with the connected state;
transitioning from the connected state to one of an idle state or an inactive state;
performing, while operating in the idle state or the inactive state, a second set of quality of experience measurements in accordance with a second quality of experience measurement and reporting configuration associated with the idle state, the inactive state, or both, the second quality of experience measurement and reporting configuration different from the first quality of experience measurement and reporting configuration; and
transmitting, to a network entity, a quality of experience report including at least the second set of quality of experience measurements.

29. The method of claim 28, further comprising:
receiving, from the network entity, a control message instructing the UE to transition from the connected state to the idle state or the inactive state, the control message modifying one or more parameters associated with the first quality of experience measurement and reporting configuration, wherein transitioning to the idle state or the inactive state is based at least in part on the control message, and wherein the second quality of experience measurement and reporting configuration comprises a modified version of the first quality of experience measurement and reporting configuration based at least in part on the control message.

30. A method for wireless communication at a network entity, comprising:
outputting, to a user equipment (UE), a first control message indicating a first quality of experience measurement and reporting configuration for the UE to use to perform quality of experience measurements while in a connected state;
outputting, to the UE via the first control message or a second control message, a second quality of experience measurement and reporting configuration for the UE to use to perform quality of experience measurements while in an idle state, an inactive state, or both; and
obtaining, from the UE, a quality of experience report including a set of quality of experience measurements performed while the UE was operating in the idle state or the inactive state and in accordance with the second quality of experience measurement and reporting configuration.
